(19) United States
(12) Patent Application Publication
(10) Pub. No.: US 2025/0287460 A1
(43) Pub. Date: Sep. 11, 2025

(54) SUPPORTING CELL DISCONTINUOUS TRANSMISSION (DTX) / DISCONTINUOUS RECEPTION (DRX) CONFIGURATION IN E2 SERVICE MODEL FOR CELL CONFIGURATION AND CONTROL (E2SM-CCC)

(71) Applicant: Intel Corporation, Santa Clara, CA (US)

(72) Inventors: Dawei Ying, Portland, OR (US); Lili Wei, Portland, OR (US); Hosein Nikopour, San Jose, CA (US); Qian Li, Beaverton, OR (US)

(73) Assignee: Intel Corporation, Santa Clara, CA (US)

(21) Appl. No.: 19/220,350

(22) Filed: May 28, 2025

Related U.S. Application Data
(60) Provisional application No. 63/652,613, filed on May 28, 2024.

(51) Int. Cl. H04W 76/28; H04W 52/02

(52) U.S. Cl. CPC H04W 76/28; H04W 52/0203

(57) ABSTRACT

A machine-readable storage medium, an apparatus and a method, each corresponding to either an apparatus to implement an E2 node in a radio-access network (RAN) of an Open Radio Access Network (O-RAN) or to an apparatus to implement a Near-Real-Time RAN-Intelligent-Controller (Near-RT RIC) to communicate with an E2 node in a RAN of an O-RAN. The apparatus to implement the E2 node in a RAN is to: determine a Near-Real-Time RAN-Intelligent-Controller (Near-RT RIC) communication from an E2 interface, the Near RT RIC communication including a cell-level energy-saving configuration information element (0-CellDTXDRX-Config IE); configure a discontinuous transmission or reception (DTX/DRX) operation of the RAN in a cell of the RAN based on the O-CellDTXDRX-Config IE; and cause the RAN's DTX/DRX operation based on the O-CellDTXDRX-Config IE.

### CROSS REFERENCE TO RELATED APPLICATIONS

This application claims the benefit of and priority from U.S. Provisional Patent Application No. 63/652,613 entitled “SUPPORTING CELL DISCONTINUOUS TRANSMISSION (DTX)/DISCONTINUOUS RECEPTION (DRX) CONFIGURATION IN E2SM-CCC,” filed May 28, 2024, the entire disclosure of which is incorporated herein by reference.

### BACKGROUND

In conventional wireless communication networks, particularly those based on Long Term Evolution (LTE) and early Fifth Generation (5G) New Radio (NR) standards, energy efficiency techniques such as discontinuous transmission (DTX) and discontinuous reception (DRX) have typically been configured in a static or semi-static manner by network operators or equipment vendors. These mechanisms, as specified in Third Generation Partnership Project (3GPP) technical specifications (e.g., TS 36.331 for LTE and TS 38.331 for 5G NR), have contributed to network energy savings (NES), particularly at the device level. However, their effectiveness is constrained by limited adaptability to real-time network dynamics and a lack of standardized support for cell-level optimization or cross-vendor interoperability. Existing implementations generally do not support dynamic, cell-specific tuning of DTX/DRX parameters in response to fluctuating traffic patterns, user mobility, or quality-of-service (QoS) requirements.

### BRIEF DESCRIPTION OF THE DRAWINGS

FIG. 1 illustrates an example of an O-RAN logical architecture.

FIG. 2 illustrates a method according to one embodiment.

FIG. 3 illustrates a network that is to operate in a manner consistent with Third Generation Partnership Project (3GPP) technical specifications for Long Term Evolution (LTE) or Fifth Generation/New Radio (5G/NR) systems.

FIG. 4 illustrates a wireless network in accordance with various embodiments.

FIG. 5 illustrates a block diagram of components, according to some example embodiments, able to read instructions from a machine-readable or computer-readable medium (e.g., a non-transitory machine-readable storage medium).

FIG. 6 illustrates a high-level view of an Open RAN (O-RAN) architecture, comparable in some aspects to that of the architecture of FIG. 1.

FIG. 7 illustrates an O-RAN logical architecture corresponding to the O-RAN architecture of FIG. 6.

FIG. 8 illustrates a wireless network to operate in a matter consistent with 3GPP technical specifications or technical reports for 6G systems.

FIG. 9 illustrates a simplified block diagram of artificial (AI)-assisted communication between a User Equipment (UE) and a Radio Access Network (RAN).

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A or B” and “A/B” mean (A), (B), or (A and B).

Various embodiments described herein generally relate to the field of wireless communications. Wireless communications have become a critical component of modern connectivity, enabling mobile broadband, the Internet of Things (IoT), and a wide range of data-driven applications. As wireless networks evolve, there is a growing need for increased efficiency, flexibility, and intelligence within the network infrastructure.

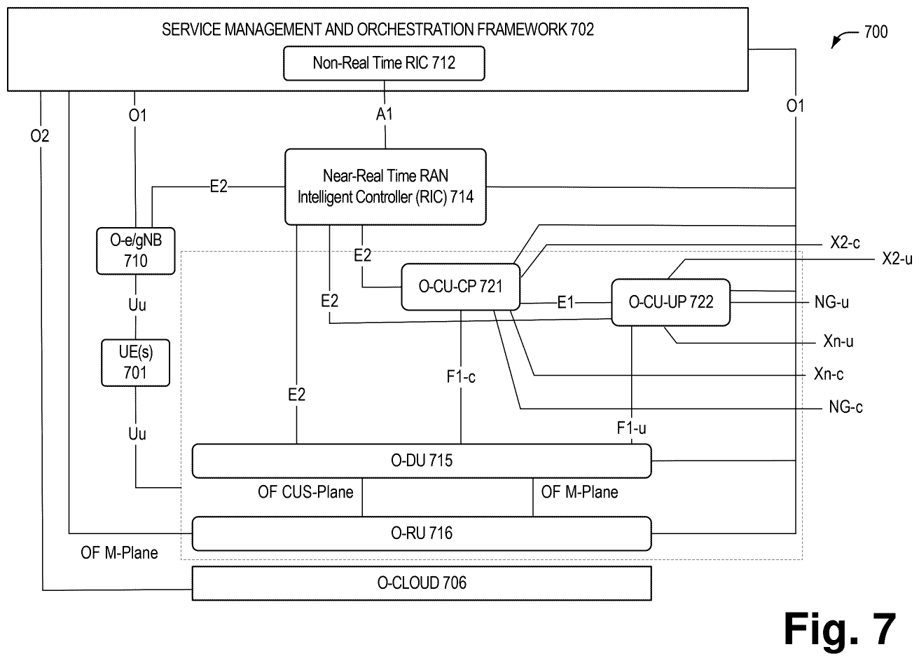

Open Radio Access Network (O-RAN) is a global industry initiative designed to make wireless networks more flexible, cost-effective, and innovative by introducing open interfaces and modular components into the Radio Access Network (RAN). This openness allows different vendors' equipment and software to work together, which fosters competition and encourages the development of advanced technologies. One of the key advancements O-RAN is enabling is the integration of artificial intelligence (AI) and machine learning (ML) into mobile networks. This is being done through the use of specialized network controllers called RAN Intelligent Controllers (RICs), which come in two types: a Non-Real-Time RIC (Non-RT RIC) (used for long-term planning and policy enforcement) and a Near-Real-Time RIC (Near RT RIC) (used for rapid, ongoing network adjustments). See for example FIG. 7 described in further detail below, which shows an O-RAN logical architecture 700 including a Near RT RIC 714 and a Non RT RIC 712 communicatively coupled via an A1 interface.

The Near RT RIC can run software applications called xApps, developed by third parties, which are capable of making real-time decisions to improve network performance. One way these xApps can help is by optimizing how the network uses discontinuous transmission (DTX) and discontinuous reception (DRX). DTX and DRX are energy-saving features in wireless communication that allow network devices, such as base stations and user equipment, to periodically turn off their transmitters or receivers when no data is being sent or received. This helps save power and reduce interference, especially in low-traffic scenarios. However, configuring DTX/DRX patterns too rigidly or incorrectly can negatively impact performance, such as increasing delays in data transmission.

By applying A1 and ML, these xApps can dynamically adjust DTX/DRX settings-such as the timing of when the device wakes up or sleeps (e.g., cellDTXDRX-CycleStartOffset), how long it remains awake (ceIIDTXDRX-onDurationTimer), timing alignment across network slots (ceIIDTXDRX-SlotOffset), whether the mode is currently active (cellDTXDRXactivationStatus), and the overall configuration type (cellDTXDRXconfigType). The A1-enhanced xApp can continuously analyze real-time network conditions and user behavior to fine-tune these parameters, ultimately leading to improved energy efficiency, reduced radio interference, and a better experience for end users.

Aspects related to cell discontinuous transmission and cell discontinuous reception (cell DTX/DRX) are described in the Third Generation Partnership Project (3GPP) Release 18 (Rel-18) specifications as a network energy saving (NES) feature. The NES feature is designed to reduce overall power consumption in the network by allowing cells to enter low-power states during periods of low activity, thus extending equipment lifespan and reducing operational costs, as alluded to above. However, aspects of cell DTX/DRX may not yet be explicitly described by the relevant O-RAN specifications.

Embodiments described herein pertain to enhancements of the E2 Service Model known as Cell Configuration and Control (E2SM-CCC), which operates within the E2 interface of the Open Radio Access Network (O-RAN) architecture. See for example FIG. 7 described in further detail below, which shows an O-RAN logical architecture 700 including a Near RT RIC 714 and an O-CU-UP 722 communicatively coupled via an E2 interface.

Some embodiments propose enhancements to the E2SM-CCC that introduce support for managing DTX and DRX parameters. DTX and DRX are power-saving mechanisms wherein the network and user equipment (UE) can enter low-power states by suspending transmission or reception during periods of inactivity. DTX refers to the intentional halting of downlink transmissions, while DRX refers to scheduled periods during which the UE does not monitor the downlink for incoming data, allowing it to conserve battery life.

The E2 interface-commonly referred to simply as “E2”—is a standardized communication link defined by the O-RAN Alliance that enables interaction between the Near-RT RIC and underlying radio network functions, such as distributed units (DUs) or central units (CUs). The Near-RT RIC is a software-based controller situated in the O-RAN architecture with the capability to make intelligent decisions and exert control over RAN behavior. It serves as an enabler for near-real-time optimization, resource management, and policy enforcement. The Near-RT RIC can host third-party applications (xApps) that use artificial intelligence (AI) and machine learning (ML) algorithms to dynamically adjust radio parameters based on changing network conditions, service demands, or energy efficiency goals.

Within the above framework, the E2SM-CCC defines a specific set of messages, data models, and procedures that allow the Near-RT RIC to configure and control radio cell parameters via the E2 interface. The E2SM-CCC, rather than being a standalone software program, comprises a set of specifications that define the structure, semantics, and procedures for exchanging control and configuration messages between a Near RT RIC RAN Intelligent Controller (Near-RT RIC) and RAN nodes, such as distributed units (O-DUs) and centralized units (O-CUs). The E2 interface provides the logical and transport layer for these communications, while the E2SM-CCC defines how specific control tasks-such as mobility management, power control, and now, in some embodiments, discontinuous transmission (DTX) and discontinuous reception (DRX) control—are expressed, transmitted, and processed. Implementations of the E2SM-CCC include software components within both the Near-RT RIC and the RAN nodes that are configured to interpret and act upon the defined message structures.

By extending E2SM-CCC to include DTX/DRX configuration and control capabilities, the system advantageously enables a standards-based, vendor-neutral mechanism for issuing fine-grained energy management directives from the RIC to the RAN, thereby supporting dynamic and intelligent energy-saving strategies across multi-vendor network deployments.

The E2 interface thus enables the Near-RT RIC to either monitor (via the E2 Subscription service) or directly control (via the E2 CONTROL service) the behavior of the RAN in near real-time. The E2 CONTROL service, in particular, allows the Near-RT RIC to send operational commands or configuration updates to the RAN in a vendor-neutral way, thereby enabling intelligent, dynamic control of radio parameters and functions.

With these enhancements, the Near-RT RIC can now dynamically adjust cell-level DTX/DRX parameters-such as activation status, timing cycles, or slot offsets-based on real-time metrics like traffic patterns, time-of-day, user activity, or predefined energy optimization goals. Because the E2SM-CCC operates over the standardized, vendor-neutral E2 interface, these energy-saving measures can be advantageously uniformly deployed across a heterogeneous RAN environment that includes equipment from multiple vendors. This interoperability furthers an objective of the O-RAN initiative: namely, openness, flexibility, and intelligent automation within the mobile network.

### Context Related to Supporting Cell DTX/DRX in E2 Interface

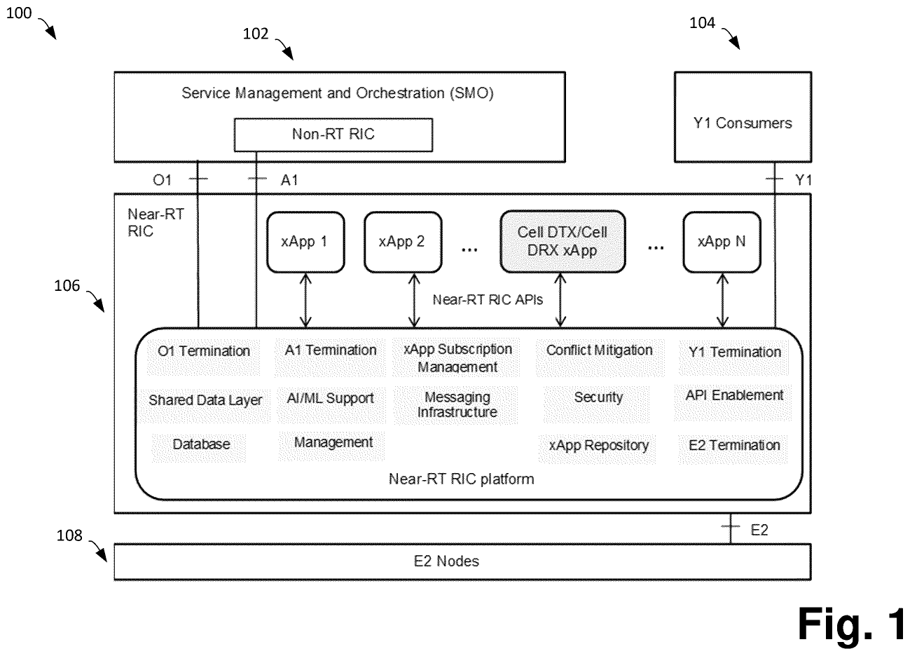

Reference is now made to FIG. 1, which shows an O-RAN architecture 100 including

FIG. 1 provides a high-level view of an Open RAN (O-RAN) architecture 100. The O-RAN architecture 100 shows some O-RAN defined interfaces—such as the O1 interface—which connects the Service Management and Orchestration (SMO) framework 102 to the Near RT RIC platform of the Near RT RIC 106, the Near RT RIC platform hosting among others xApps. Additionally, the A1 interface connects the Non-RT RIC hosted within SMO 102 to the Near-RT RIC platform. Y1 consumers 104 are also connected to the Near RT RIC platform by way of a Y1 interface, while E2 nodes, such as O-DUs or O-CUs, are connected to the Near RT RIC 106 via an E2 interface. FIG. 7, described in further detail below, provides a more detailed overview of an example O-RAN architecture, and, as a result, those same details will not be provided again here in relation to FIG. 1.

In particular, an aim of FIG. 1 is to illustrate the Near RT RIC as hosting an xApp in the form of a DTX/DRX application-referred to herein as a cell DTX/DRX xApp-which may be deployed within a Near-RT RIC to intelligently design and control cell-level DTX/DRX radio resource control (RRC) patterns. These patterns define how and when a cell transmits or listens to wireless signals in a discontinuous manner, allowing the network to reduce power consumption during periods of low activity without compromising connectivity.

To support such functionality, the configuration of cell-level DTX/DRX behavior may be executed through the E2 interface.

The O-RAN Working Group 3 (WG3) has introduced a suite of E2 Service Models (E2SMs), which define the specific RAN-function-dependent information elements (IEs) and procedures for network management and optimization tasks. Examples of these E2SMs include:
The E2SM-NI (Network Interface), which allows for the exposure and policy-driven modification of network interface messages, enabling changes to overall network behavior;
The E2SM-KPM (Key Performance Measurements Monitor), which enables the Near-RT RIC to receive, monitor, and subscribe to performance measurements from O-DUs, O-CU-CPs (Control Plane), and O-CU-UPs (User Plane);
The E2SM-RC (RAN Control), which supports the exposure and manipulation of user equipment (UE) context and RAN control-related signaling and procedures; and
The E2SM-CCC (Cell Configuration and Control), which enables both the reporting and configuration of node-level and cell-level parameters, making it particularly well suited for cell-specific control such as DTX/DRX.

Because DTX/DRX patterns are inherently specific to individual cells, the E2SM-CCC service model provides a standardized mechanism for defining and managing these configurations. Through extensions to E2SM-CCC according to some embodiments, the Near-RT RIC can issue precise, real-time or near-real-time control directives to RAN nodes that adjust DTX/DRX settings dynamically based on traffic load, time of day, user behavior, or energy efficiency goals. This approach is compatible with goals of the O-RAN architecture, which emphasizes openness, vendor neutrality, and intelligent network automation across heterogeneous network environments.

### Cell DTX/DRX in E2SM-CCC

In some embodiments, enhancements to E2SM-CCC enable cell-level DTX/DRX control within the O-RAN architecture. Specifically, a new RAN configuration structure referred to as O-CellDTXDRX-Config information element (IE) is being proposed to be added to E2SM-CCC (e.g., Clause 8.2.2) to support configuration of DTX/DRX parameters. The O-CellDTXDRX-Config structure defines attributes necessary for configuring and managing cell-level DTX/DRX behavior, including parameters such as on-duration timers, activation status, and cycle offsets. This structure is part of a broader set of configuration elements defined in E2SM-CCC, including O-NRCellCU, O-NRCellDU, O-BWP, O-RRMPolicyRatio, O-CESManagementFunction, and O-NESPolicy. Each of these represents a standardized structure for configuring a different aspect of RAN behavior. By incorporating O-CellDTXDRX-Config into E2SM-CCC, the Near-RT RIC can issue DTX/DRX configuration commands to gNB components over the E2 interface using the E2 CONTROL service. This enables fine-grained, dynamic, and vendor-neutral energy-saving control at the cell level, aligned with O-RAN's goals of openness and multi-vendor interoperability.

For example, a new RAN configuration structure for cell DTX/DRX may be added to E2SM-CCC (e.g., Clause 8.2.2) as O-CellDTXDRX-Config as suggested below in Table 1:

TABLE 1

| | RAN | |
|---|---|---|
| | Configuration | |
| RAN Configuration | Structure | |
| Structure Name | Definition | Semantics Description |
| O-NRCellCU | 8.8.2.1 | Represents O-NRCellCU attributes |
| | | defined in 8.8.2.1. |
| O-NRCellDU | 8.8.2.2 | Represents O-NRCellDU attributes |
| | | defined in 8.8.2.2. |
| O-BWP | 8.8.2.3 | Represents O-BWP attributes defined |
| | | in 8.8.2.3. |
| O-RRMPolicyRatio | 8.8.2.4 | Represents O-RRMPolicyRatio |
| | | attributes defined in 8.8.2.4. |
| O- | 8.8.2.5 | Represents O- |
| CESManagementFunction | | CESManagementFunction attributes |
| | | defined in 8.8.2.5. |
| O-NESPolicy | 8.8.2.6 | Represents O-NESPolicy attributes |
| | | defined in 8.8.2.6. |
| O-CellDTXDRX-Config | 8.8.2.x | Represents O-CellDTXDRX-Config |
| | | attributes defined in 8.8.2.x |

### O-CellDTXDRX-Config

In some embodiments, the O-CellDTXDRX-Config Information Element (IE) defined in the E2SM-CCC, for example as described in Clause 8.8.2.x, specifies the DTX and DRX configuration for a serving cell. This IE comprises a set of writable parameters that support both REPORT and CONTROL services, thereby enabling dynamic configuration through the E2 interface as managed by the Near-RT RIC.

Thus, the O-CellDTXDRX-Config IE may embody the cell DTX/DRX configuration of a serving cell, and may be defined as set forth in Table 2 below:

TABLE 2

| | Supported | Is | IE type and | |
|---|---|---|---|---|
| IE/Group Name | Services | writable | reference | Semantics description |
| onDurationTimer | REPORT, | TRUE | 9.3.y | Refer to 3GPP TS 38.331, |
| | CONTROL | | | clause 6.3.2, |
| | | | | “cellDTXDRX- |
| | | | | onDurationTimer” |
| | | | | description |
| cycleStartOffset | REPORT, | TRUE | 9.3.z1 or 9.3.z2 | Refer to 3GPP TS 38.331, |
| | CONTROL | | | clause 6.3.2, |
| | | | | “cellDTXDRX- |
| | | | | CycleStartOffset” |
| | | | | description |
| slotOffset | REPORT, | TRUE | INTEGER | Value in multiple of 1/32 |
| | CONTROL | | (0 . . . 31) | ms. Value 1 corresponds |
| | | | | to 1/32 ms, value 2 |
| | | | | corresponds to 2/32 ms, |
| | | | | and so on Refer to 3GPP |
| | | | | TS 38.331, clause 6.3.2, |
| | | | | “cellDTXDRX-SlotOffset” |
| | | | | description |
| configType | REPORT, | TRUE | ENUMERATED | Indicates whether the |
| | CONTROL | | (DTX, DRX, | configuration is for cell |
| | | | DTXDRX) | DTX only, cell DRX only, |
| | | | | or joint cell DTX/DRX |
| | | | | configuration. Refer to |
| | | | | 3GPP TS 38.331, clause |
| | | | | 6.3.2, |
| | | | | “cellDTXDRXconfiType” |
| | | | | description |
| activationStatus | REPORT, | TRUE | ENUMERATED | Initial activation status of |
| | CONTROL | | (ACTIVATED, | cell DTX/DRX. Refer to |
| | | | DEACTIVATED) | 3GPP TS 38.331, clause |
| | | | | 6.3.2, |
| | | | | “cellDTXDRXactivationStatus” |
| | | | | description |
| l1Activation | REPORT, | TRUE | ENUMERATED | Indicates whether the |
| | CONTROL | | (ENABLED, | cell enables L1 signaling |
| | | | DISABLED) | (DCI 2_9) for dynamic |
| | | | | activation/deactivation |
| | | | | of cell DTX/DRX |
| | | | | configuration. Refer to |
| | | | | 3GPP TS 38.331, clause |
| | | | | 6.3.2, “cellDTXDRX- |
| | | | | L1activation” description |

An onDurationTimer parameter of the O-CellDTXDRX-Config Information IE may define the duration that a cell can remain active after being triggered. This parameter may be initially configured by the gNB as an RRC parameter based on baseline service requirements, but then it may be dynamically adjusted by the Near-RT RIC through the O-CellDTXDRX-Config Information IE to optimize energy savings and latency in response to real-time network conditions, potentially using AI/ML.

The onDurationTimer IE may be defined as a choice between two fields: subMilliSeconds and milliSeconds, only one of which may be present at a time. The subMilliSeconds field is represented as an integer ranging from 1 to 31, where each unit corresponds to 1/32 ms, enabling fine-grained configuration for short-duration on-periods. Alternatively, the milliSeconds field is defined as an enumerated value selected from a set of predefined durations, such as ms1, ms2, ms5, ms10, up to ms1600, where each enumerated value corresponds to its labeled millisecond duration. These fields align with the specifications in 3GPP TS 38.331, clause 6.3.2, for the cellDTXDRX-onDurationTimer parameter, and allow the gNB or Near-RT RIC to tailor the active time window based on energy efficiency targets, latency requirements, or real-time traffic patterns.

Examples for the onDurationTimer IE are provided below, according to some embodiments, in Table 3:

TABLE 3

| | | | | |
|---|---|---|---|---|
| | | | IE type and | |
| IE/Group Name | Presence | Range | reference | Semantics description |

| | | | |
|---|---|---|---|
| CHOICE | | | Cell DTX/DRX duration. Refer |
| onDurationTimer | | | to 3GPP TS 38.331, clause |
| | | | 6.3.2, “cellDTXDRX- |
| | | | onDurationTimer” |
| | | | description |
| >subMilliSeconds | C | INTEGER (1 . . . 31) | Value in multiples of 1/32 |
| | | | ms. See NOTE. |
| >milliSeconds | C | ENUMERATED | Value in ms. Enum value ms1 |
| | | (ms1, ms2, ms3, | corresponds to 1 ms, enum |
| | | ms4, ms5, ms6, | value ms2 corresponds to 2 |
| | | ms8, ms10, | ms, and so on. See NOTE. |
| | | ms20, ms40, | |
| | | ms50, ms60, | |
| | | ms80, ms100, | |
| | | ms200, ms300, | |
| | | ms400, ms500, | |
| | | ms600, ms800, | |
| | | ms1000, | |
| | | ms1200, | |
| | | ms1600) | |

NOTE:
One and only one of the choices shall be present.

The cycleStartOffset information element (IE) may define the periodicity and offset for a serving cell's DTX/DRX cycle. This IE may be structured as a choice among multiple predefined periodicity options, each corresponding to a specific cycle duration expressed in milliseconds. For each selected periodicity—such as 10 ms, 20 ms, 40 ms, 128 ms, 1024 ms, and up to 10240 ms—an associated integer offset value may be used to indicate the start point of the DTX/DRX cycle within the period. The offset values may be specified in 1 ms increments, and the range of allowable offset values may increase proportionally with the selected periodicity (e.g., a value from 0 to 1279 for a 1280 ms cycle). This flexible structure may allow precise alignment of sleep and wake intervals with respect to other cell operations and user activity. Only one periodicity option may be selected per configuration instance. The cycleStartOffset IE may align with the definitions provided in 3GPP TS 38.331, clause 6.3.2, and may enable fine-grained control over when a cell enters low-power or active states, supporting dynamic adaptation for traffic-aware energy savings or quality-of-service objectives. In practice, the gNB may initially configure the cycleStartOffset value, for example, by transmitting it to UEs via RRC signaling as part of the cell's DTX/DRX configuration. This initial configuration allows the gNB to align the cell's energy-saving cycles with broader network scheduling requirements. Subsequently, the Near-RT RIC may dynamically adjust the cycleStartOffset parameter by sending updated values to the gNB through the E2 CONTROL service according to some embodiments. Such dynamic adjustments may be informed by real-time analytics or AI/ML models operating in the Near-RT RIC, which may detect emerging network conditions such as increased traffic demand, critical network events, or the need to synchronize with the DRX cycles of specific UEs. Upon receiving an updated cycleStartOffset from the Near-RT RIC, the gNB may propagate this change to UEs either through further RRC reconfiguration messages for persistent changes or via rapid L1 signaling, such as through DCI 2_9, for temporary or urgent adjustments.

Examples for the cycleStartOffset IE are provided below, according to some embodiments, in Table 4 below:

TABLE 4

| | | | | |
|---|---|---|---|---|
| | | | IE type and | |
| IE/Group Name | Presence | Range | reference | Semantics description |

| | | | |
|---|---|---|---|
| CHOICE | | | Cell DTX/DRX periodicity and |
| cycleStartOffset | | | offset. Refer to 3GPP TS |
| | | | 38.331, clause 6.3.2, |
| | | | “cellDTXDRX-CycleStartOffset” |
| | | | description. |
| >ms10 | C | INTEGER (0 . . . 9) | 10 ms periodicity and offset in |
| | | | multiples of 1 ms. See NOTE. |
| >ms20 | C | INTEGER (0 . . . 19) | 20 ms periodicity and offset in |
| | | | multiples of 1 ms. See NOTE. |
| >ms32 | C | INTEGER (0 . . . 31) | 32 ms periodicity and offset in |
| | | | multiples of 1 ms. See NOTE. |
| >ms40 | C | INTEGER (0 . . . 39) | 40 ms periodicity and offset in |
| | | | multiples of 1 ms. See NOTE. |
| >ms60 | C | INTEGER (0 . . . 59) | 60 ms periodicity and offset in |
| | | | multiples of 1 ms. See NOTE. |
| >ms64 | C | INTEGER (0 . . . 63) | 64 ms periodicity and offset in |
| | | | multiples of 1 ms. See NOTE. |
| >ms70 | C | INTEGER (0 . . . 69) | 70 ms periodicity and offset in |
| | | | multiples of 1 ms. See NOTE. |
| >ms80 | C | INTEGER (0 . . . 79) | 80 ms periodicity and offset in |
| | | | multiples of 1 ms. See NOTE. |
| >ms128 | C | INTEGER (0 . . . 127) | 128 ms periodicity and offset |
| | | | in multiples of 1 ms. See NOTE. |
| >ms160 | C | INTEGER (0 . . . 159) | 160 ms periodicity and offset |
| | | | in multiples of 1 ms. See NOTE. |
| >ms256 | C | INTEGER (0 . . . 255) | 256 ms periodicity and offset |
| | | | in multiples of 1 ms. See NOTE. |
| >ms320 | C | INTEGER (0 . . . 319) | 320 ms periodicity and offset |
| | | | in multiples of 1 ms. See NOTE. |
| >ms512 | C | INTEGER (0 . . . 511) | 512 ms periodicity and offset |
| | | | in multiples of 1 ms. See NOTE. |
| >ms640 | C | INTEGER (0 . . . 639) | 640 ms periodicity and offset |
| | | | in multiples of 1 ms. See NOTE. |
| >ms1024 | C | INTEGER (0 . . . 1023) | 1024 ms periodicity and offset |
| | | | in multiples of 1 ms. See NOTE. |
| >ms1280 | C | INTEGER (0 . . . 1279) | 1280 ms periodicity and offset |
| | | | in multiples of 1 ms. See NOTE. |
| >ms2048 | C | INTEGER (0 . . . 2047) | 2048 ms periodicity and offset |
| | | | in multiples of 1 ms. See NOTE. |
| >ms2560 | C | INTEGER (0 . . . 2559) | 2560 ms periodicity and offset |
| | | | in multiples of 1 ms. See NOTE. |
| >ms5120 | C | INTEGER (0 . . . 5119) | 5120 ms periodicity and offset |
| | | | in multiples of 1 ms. See NOTE. |
| >ms10240 | C | INTEGER (0 . . . 10239) | 10240 ms periodicity and |
| | | | offset in multiples of 1 ms. See |
| | | | NOTE. |

NOTE:
One and only one of the choices shall be present.

An alternative example/definition of cycleStartOffset IE may include the information provided in Table 5 below:

TABLE 5

| | | | | |
|---|---|---|---|---|
| IE/Group Name | Presence | Range | IE type and reference | Semantics description |

| | | | |
|---|---|---|---|
| cycleStartOffset | | | Cell DTX/DRX periodicity and offset. |
| | | | Refer to 3GPP TS 38.331, clause |
| | | | 6.3.2, “cellDTXDRX-CycleStartOffset” |
| | | | description |
| >periodicity | M | ENUMERATED (ms10, | Value in ms. Enum value ms10 |
| | | ms20, ms32, ms40, | corresponds to 10 ms, enum value |
| | | ms60, ms64, ms70, | ms20 corresponds to 20 ms, and so |
| | | ms80, ms128, ms160, | on. See NOTE. |
| | | ms256, ms320, ms512, | |
| | | ms640, ms1024, ms1280, | |
| | | ms2048, ms2560, | |
| | | ms5120, ms10240) | |
| >offset | M | INTEGER (0 . . . 10239) | Value in ms. |

According to the alternative presented above for cycleStartOffset in Table 5, the IE may include two components: a periodicity field and an offset field. The periodicity field may be an enumerated value indicating the duration of the cycle, with options including 10 ms, 20 ms, 32 ms, 40 ms, 60 ms, 64 ms, 70 ms, 80 ms, and extending up to 10240 ms. Each enumerated value may correspond to a specific cycle duration in milliseconds, such that ms10 may represent a 10 ms cycle, ms20 a 20 ms cycle, and so forth. The offset field may define a timing offset within the selected periodicity, expressed as an integer value in milliseconds, ranging from 0 up to 10239 depending on the chosen cycle length. This structure may provide a standardized way to fine-tune the timing of DTX/DRX operation to align with traffic patterns or inter-cell coordination requirements. The definitions and permissible values for this IE may correspond to those specified in 3GPP TS 38.331, clause 6.3.2.

The slotOffset parameter of the O-CellDTXDRX-Config IE provides fine timing granularity, for example in increments of 1/32 ms, enabling both the gNB and Near-RT RIC to precisely align the start of active durations within a subframe. During initial configuration, the gNB may set the slotOffset value based on network planning, synchronization requirements, and anticipated traffic patterns, typically communicating this value to UEs as part of the DTX/DRX configuration through RRC signaling. Subsequently, the slotOffset parameter may be dynamically adjusted by the Near-RT RIC, which sends updated values to the gNB via the E2 CONTROL service in E2SM-CCC according to some embodiments. These dynamic adjustments may be informed by real-time analytics or AI/ML models that detect changes in network load, interference patterns, or the need to coordinate active periods across multiple cells or vendors. By providing sub-millisecond precision and enabling both initial and dynamic configuration, the slotOffset parameter delivers technical advantages such as reduced latency, improved reliability for time-sensitive and mission-critical applications, and seamless interoperability in multi-vendor open RAN environments.

The configType parameter of the O-CellDTXDRX-Config IE indicates whether the cell is configured for DTX, DRX, or combined DTX/DRX operation. During initial configuration, the gNB may select the appropriate configType based on anticipated traffic profiles, service requirements, and network policies, and may communicate this setting to UEs through RRC signaling. The configType parameter can also be modified dynamically by the Near-RT RIC through the configType parameter, where the Near RT RIC may instruct the gNB to switch operational modes in response to real-time network analytics, AI/ML-driven predictions, or sudden changes in uplink or downlink demand. This flexibility allows the network to adapt to shifting usage patterns, congestion, or service-level agreements without manual intervention.

The activationStatus parameter of the O-CellDTXDRX-Config IE determines whether the DTX/DRX configuration is currently active or inactive for the cell. The activation state refers to whether the energy-saving behavior defined by the DTX/DRX parameters is being applied by the cell at a given time. During initial configuration, the gNB may set this parameter to activate the cell DTX/DRX configuration immediately, or to leave it inactive until a later trigger. Additionally, the Near-RT RIC can instruct the gNB to change the activationStatus parameter rapidly in response to evolving network priorities, such as emergencies, maintenance, or traffic surges. This allows the network to promptly enable or disable energy-saving features as needed, ensuring that DTX/DRX mechanisms are only active when appropriate and do not interfere with critical services or degrade user experience. By supporting both static and dynamic activation or deactivation of cell DTX/DRX, the network can optimize energy efficiency, minimize operational costs, and maintain high service continuity even as network conditions fluctuate.

The I1Activation parameter determines whether L1 signaling, such as through DCI 2_9 as introduced in 3GPP Release 18, is enabled to permit dynamic activation or deactivation of the configuration at the physical layer. This mechanism allows the gNB to make rapid, low-latency adjustments to cell energy-saving behavior without relying solely on higher-layer signaling. The Near-RT RIC can leverage this capability to trigger immediate changes in DTX/DRX status in response to predicted traffic fluctuations, network events, or AI/ML-driven insights. By enabling fast, physical-layer control, the I1Activation parameter reduces the need for more disruptive RRC-based reconfiguration, supporting greater network agility and minimizing service interruptions during dynamic network conditions.

Collectively, these parameters provide precise, dynamic, and cell-specific control over energy-saving behavior, allowing for significant improvements in power efficiency, reduced operational costs, and enhanced service quality, all managed in a coordinated fashion by the Near-RT RIC through the E2 CONTROL service and in alignment with the specifications of 3GPP TS 38.331 and O-RAN Alliance standards. By enabling real-time and intelligent adjustment of DTX/DRX parameters at the cell level, the described approach offers technical advantages such as improved energy efficiency, reduced signaling latency, and enhanced adaptability to diverse traffic patterns and service requirements in next-generation wireless networks.

Flow diagrams as illustrated herein provide examples of sequences of various process actions. The flow diagrams can indicate operations to be executed by a software or firmware routine, as well as physical operations. In some embodiments, a flow diagram can illustrate the state of a finite state machine (FSM), which can be implemented in hardware and/or software. Although shown in a particular sequence or order, unless otherwise specified, the order of the actions can be modified. Thus, the illustrated embodiments should be understood only as an example, and the process can be performed in a different order, and some actions can be performed in parallel. Additionally, one or more actions can be omitted in various embodiments; thus, not all actions are required in every embodiment. Other process flows are possible.

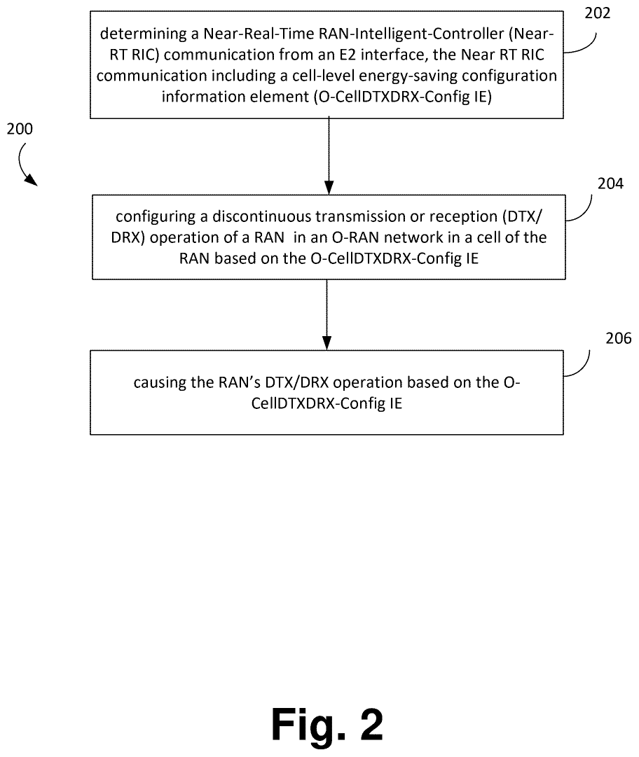

FIG. 2 is a flow diagram depicting a process 200 to be performed at an apparatus to implement an E2 node in a radio-access network (RAN) of an Open Radio Access Network (O-RAN) according to some embodiments. At operation 202, the process includes determining a Near-Real-Time RAN-Intelligent-Controller (Near-RT RIC) communication from an E2 interface, the Near RT RIC communication including a cell-level energy-saving configuration information element (O-CellDTXDRX-Config IE). At operations 204, the process includes configuring a discontinuous transmission or reception (DTX/DRX) operation of the RAN in a cell of the RAN based on the O-CellDTXDRX-Config IE. At operation 206, the process includes causing the RAN's DTX/DRX operation based on the O-CellDTXDRX-Config IE.

### Systems and Implementations

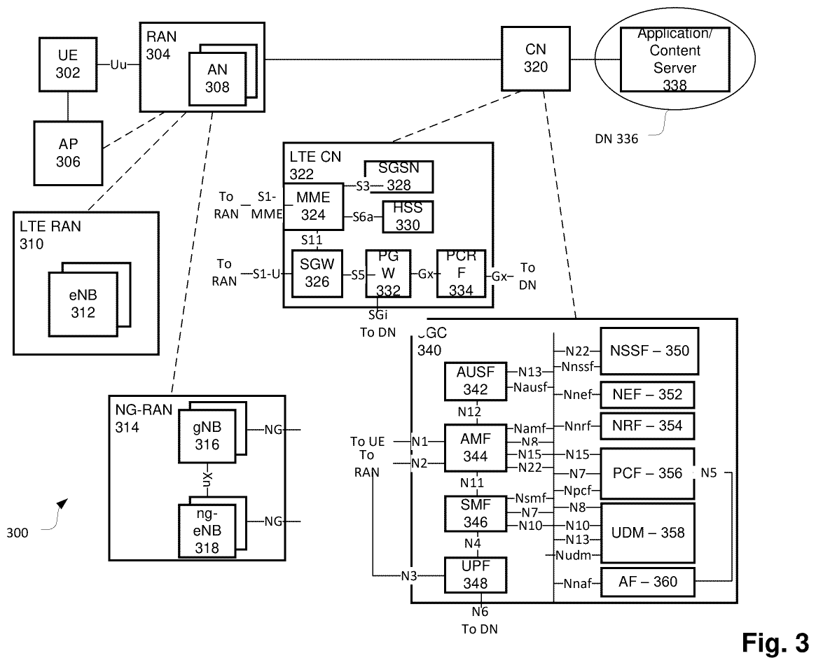

FIGS. 3-9 illustrate various systems, devices, and components that may implement aspects of disclosed embodiments.

FIG. 3 illustrates a network 300 in accordance with various embodiments. The network 300 may operate in a manner consistent with 3GPP technical specifications for LTE or 5G/NR systems. However, the example embodiments are not limited in this regard and the described embodiments may apply to other networks that benefit from the principles described herein, such as future 3GPP systems, or the like.

The network 300 may include a UE 302, which may include any mobile or non-mobile computing device designed to communicate with a RAN 304 via an over-the-air connection. The UE 302 may be communicatively coupled with the RAN 304 by a Uu interface. The UE 302 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

In some embodiments, the network 300 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc.

In some embodiments, the UE 302 may additionally communicate with an AP 306 via an over-the-air connection. The AP 306 may manage a WLAN connection, which may serve to offload some/all network traffic from the RAN 304. The connection between the UE 302 and the AP 306 may be consistent with any IEEE 802.11 protocol, wherein the AP 306 could be a wireless fidelity (Wi-Fi®) router. In some embodiments, the UE 302, RAN 304, and AP 306 may utilize cellular-WLAN aggregation (for example, LWA/LWIP). Cellular-WLAN aggregation may involve the UE 302 being configured by the RAN 304 to utilize both cellular radio resources and WLAN resources.

The RAN 304 may include one or more access nodes, for example, AN 308. AN 308 may terminate air-interface protocols for the UE 302 by providing access stratum protocols including RRC, PDCP, RLC, MAC, and L1 protocols. In this manner, the AN 308 may enable data/voice connectivity between CN 320 and the UE 302. In some embodiments, the AN 308 may be implemented in a discrete device or as one or more software entities running on server computers as part of, for example, a virtual network, which may be referred to as a CRAN or virtual baseband unit pool. The AN 308 be referred to as a BS, gNB, RAN node, eNB, ng-eNB, NodeB, RSU, TRxP, TRP, etc. The AN 308 may be a macrocell base station or a low power base station for providing femtocells, picocells or other like cells having smaller coverage areas, smaller user capacity, or higher bandwidth compared to macrocells.

In embodiments in which the RAN 304 includes a plurality of ANs, they may be coupled with one another via an X2 interface (if the RAN 304 is an LTE RAN) or an Xn interface (if the RAN 304 is a 5G RAN). The X2/Xn interfaces, which may be separated into control/user plane interfaces in some embodiments, may allow the ANs to communicate information related to handovers, data/context transfers, mobility, load management, interference coordination, etc.

The ANs of the RAN 304 may each manage one or more cells, cell groups, component carriers, etc. to provide the UE 302 with an air interface for network access. The UE 302 may be simultaneously connected with a plurality of cells provided by the same or different ANs of the RAN 304. For example, the UE 302 and RAN 304 may use carrier aggregation to allow the UE 302 to connect with a plurality of component carriers, each corresponding to a Pcell or Scell. In dual connectivity scenarios, a first AN may be a master node that provides an MCG and a second AN may be secondary node that provides an SCG. The first/second ANs may be any combination of eNB, gNB, ng-eNB, etc.

The RAN 304 may provide the air interface over a licensed spectrum or an unlicensed spectrum. To operate in the unlicensed spectrum, the nodes may use LAA, eLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

In V2X scenarios the UE 302 or AN 308 may be or act as a RSU, which may refer to any transportation infrastructure entity used for V2X communications. An RSU may be implemented in or by a suitable AN or a stationary (or relatively stationary) UE. An RSU implemented in or by: a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, media, as well as applications/software to sense and control ongoing vehicular and pedestrian traffic. The RSU may provide very low latency communications required for high speed events, such as crash avoidance, traffic warnings, and the like. Additionally or alternatively, the RSU may provide other cellular/WLAN communications services. The components of the RSU may be packaged in a weatherproof enclosure suitable for outdoor installation, and may include a network interface controller to provide a wired connection (e.g., Ethernet) to a traffic signal controller or a backhaul network.

In some embodiments, the RAN 304 may be an LTE RAN 310 with eNBs, for example, eNB 312. The LTE RAN 310 may provide an LTE air interface with the following characteristics: SCS of 15 kHz; CP-OFDM waveform for DL and SC-FDMA waveform for UL; turbo codes for data and TBCC for control; etc. The LTE air interface may rely on CSI-RS for CSI acquisition and beam management; PDSCH/PDCCH DMRS for PDSCH/PDCCH demodulation; and CRS for cell search and initial acquisition, channel quality measurements, and channel estimation for coherent demodulation/detection at the UE. The LTE air interface may operating on sub-6 GHz bands.

In some embodiments, the RAN 304 may be an NG-RAN 314 with gNBs, for example, gNB 316, or ng-eNBs, for example, ng-eNB 318. The gNB 316 may connect with 5G-enabled UEs using a 5G NR interface. The gNB 316 may connect with a 5G core through an NG interface, which may include an N2 interface or an N3 interface. The ng-eNB 318 may also connect with the 5G core through an NG interface, but may connect with a UE via an LTE air interface. The gNB 316 and the ng-eNB 318 may connect with each other over an Xn interface.

In some embodiments, the NG interface may be split into two parts, an NG user plane (NG-U) interface, which carries traffic data between the nodes of the NG-RAN 314 and a UPF 348 (e.g., N3 interface), and an NG control plane (NG-C) interface, which is a signaling interface between the nodes of the NG-RAN314 and an AMF 344 (e.g., N2 interface).

The NG-RAN 314 may provide a 5G-NR air interface with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operating on FR1 bands that include sub-6 GHz bands or FR2 bands that include bands from 24.25 GHz to 52.6 GHz. The 5G-NR air interface may include an SSB that is an area of a downlink resource grid that includes PSS/SSS/PBCH.

In some embodiments, the 5G-NR air interface may utilize BWPs for various purposes. For example, BWP can be used for dynamic adaptation of the SCS. For example, the UE 302 can be configured with multiple BWPs where each BWP configuration has a different SCS. When a BWP change is indicated to the UE 302, the SCS of the transmission is changed as well. Another use case example of BWP is related to power saving. In particular, multiple BWPs can be configured for the UE 302 with different amount of frequency resources (for example, PRBs) to support data transmission under different traffic loading scenarios. A BWP containing a smaller number of PRBs can be used for data transmission with small traffic load while allowing power saving at the UE 302 and in some cases at the gNB 316. A BWP containing a larger number of PRBs can be used for scenarios with higher traffic load.

The RAN 304 is communicatively coupled to CN 320 that includes network elements to provide various functions to support data and telecommunications services to customers/subscribers (for example, users of UE 302). The components of the CN 320 may be implemented in one physical node or separate physical nodes. In some embodiments, NFV may be utilized to virtualize any or all of the functions provided by the network elements of the CN 320 onto physical compute/storage resources in servers, switches, etc. A logical instantiation of the CN 320 may be referred to as a network slice, and a logical instantiation of a portion of the CN 320 may be referred to as a network sub-slice.

In some embodiments, the CN 320 may be an LTE CN 322, which may also be referred to as an EPC. The LTE CN 322 may include MME 324, SGW 326, SGSN 328, HSS 330, PGW 332, and PCRF 334 coupled with one another over interfaces (or “reference points”) as shown. Functions of the elements of the LTE CN 322 may be briefly introduced as follows.

The MME 324 may implement mobility management functions to track a current location of the UE 302 to facilitate paging, bearer activation/deactivation, handovers, gateway selection, authentication, etc.

The SGW 326 may terminate an Si interface toward the RAN and route data packets between the RAN and the LTE CN 322. The SGW 326 may be a local mobility anchor point for inter-RAN node handovers and also may provide an anchor for inter-3GPP mobility. Other responsibilities may include lawful intercept, charging, and some policy enforcement.

The SGSN 328 may track a location of the UE 302 and perform security functions and access control. In addition, the SGSN 328 may perform inter-EPC node signaling for mobility between different RAT networks; PDN and S-GW selection as specified by MME 324; MME selection for handovers; etc. The S3 reference point between the MME 324 and the SGSN 328 may enable user and bearer information exchange for inter-3GPP access network mobility in idle/active states.

The HSS 330 may include a database for network users, including subscription-related information to support the network entities' handling of communication sessions. The HSS 330 can provide support for routing/roaming, authentication, authorization, naming/addressing resolution, location dependencies, etc. An S6a reference point between the HSS 330 and the MME 324 may enable transfer of subscription and authentication data for authenticating/authorizing user access to the LTE CN 320.

The PGW 332 may terminate an SGi interface toward a data network (DN) 336 that may include an application/content server 338. The PGW 332 may route data packets between the LTE CN 322 and the data network 336. The PGW 332 may be coupled with the SGW 326 by an S5 reference point to facilitate user plane tunneling and tunnel management. The PGW 332 may further include a node for policy enforcement and charging data collection (for example, PCEF). Additionally, the SGi reference point between the PGW 332 and the data network 3 36 may be an operator external public, a private PDN, or an intra-operator packet data network, for example, for provision of IMS services. The PGW 332 may be coupled with a PCRF 334 via a Gx reference point.

The PCRF 334 is the policy and charging control element of the LTE CN 322. The PCRF 334 may be communicatively coupled to the app/content server 338 to determine appropriate QoS and charging parameters for service flows. The PCRF 332 may provision associated rules into a PCEF (via Gx reference point) with appropriate TFT and QCI.

In some embodiments, the CN 320 may be a 5GC 340. The 5GC 340 may include an AUSF 342, AMF 344, SMF 346, UPF 348, NSSF 350, NEF 352, NRF 354, PCF 356, UDM 358, and AF 360 coupled with one another over interfaces (or “reference points”) as shown. Functions of the elements of the 5GC 340 may be briefly introduced as follows.

The AUSF 342 may store data for authentication of UE 302 and handle authentication-related functionality. The AUSF 342 may facilitate a common authentication framework for various access types. In addition to communicating with other elements of the 5GC 340 over reference points as shown, the AUSF 342 may exhibit an Nausf service-based interface.

The AMF 344 may allow other functions of the 5GC 340 to communicate with the UE 302 and the RAN 304 and to subscribe to notifications about mobility events with respect to the UE 302. The AMF 344 may be responsible for registration management (for example, for registering UE 302), connection management, reachability management, mobility management, lawful interception of AMF-related events, and access authentication and authorization. The AMF 344 may provide transport for SM messages between the UE 302 and the SMF 346, and act as a transparent proxy for routing SM messages. AMF 344 may also provide transport for SMS messages between UE 302 and an SMSF. AMF 344 may interact with the AUSF 342 and the UE 302 to perform various security anchor and context management functions. Furthermore, AMF 344 may be a termination point of a RAN CP interface, which may include or be an N2 reference point between the RAN 304 and the AMF 344; and the AMF 344 may be a termination point of NAS (N1) signaling, and perform NAS ciphering and integrity protection. AMF 344 may also support NAS signaling with the UE 302 over an N3 IWF interface.

The SMF 346 may be responsible for SM (for example, session establishment, tunnel management between UPF 348 and AN 308); UE IP address allocation and management (including optional authorization); selection and control of UP function; configuring traffic steering at UPF 348 to route traffic to proper destination; termination of interfaces toward policy control functions; controlling part of policy enforcement, charging, and QoS; lawful intercept (for SM events and interface to LI system); termination of SM parts of NAS messages; downlink data notification; initiating AN specific SM information, sent via AMF 344 over N2 to AN 308; and determining SSC mode of a session. SM may refer to management of a PDU session, and a PDU session or “session” may refer to a PDU connectivity service that provides or enables the exchange of PDUs between the UE 302 and the data network 336.

The UPF 348 may act as an anchor point for intra-RAT and inter-RAT mobility, an external PDU session point of interconnect to data network 336, and a branching point to support multi-homed PDU session. The UPF 348 may also perform packet routing and forwarding, perform packet inspection, enforce the user plane part of policy rules, lawfully intercept packets (UP collection), perform traffic usage reporting, perform QoS handling for a user plane (e.g., packet filtering, gating, UL/DL rate enforcement), perform uplink traffic verification (e.g., SDF-to-QoS flow mapping), transport level packet marking in the uplink and downlink, and perform downlink packet buffering and downlink data notification triggering. UPF 348 may include an uplink classifier to support routing traffic flows to a data network.

The NSSF 350 may select a set of network slice instances serving the UE 302. The NSSF 350 may also determine allowed NSSAI and the mapping to the subscribed S-NSSAIs, if needed. The NSSF 350 may also determine the AMF set to be used to serve the UE 302, or a list of candidate AMFs based on a suitable configuration and possibly by querying the NRF 354. The selection of a set of network slice instances for the UE 302 may be triggered by the AMF 344 with which the UE 302 is registered by interacting with the NSSF 350, which may lead to a change of AMF. The NSSF 350 may interact with the AMF 344 via an N22 reference point; and may communicate with another NSSF in a visited network via an N31 reference point (not shown). Additionally, the NSSF 350 may exhibit an Nnssf service-based interface.

The NEF 352 may securely expose services and capabilities provided by 3GPP network functions for third party, internal exposure/re-exposure, AFs (e.g., AF 360), edge computing or fog computing systems, etc. In such embodiments, the NEF 352 may authenticate, authorize, or throttle the AFs. NEF 352 may also translate information exchanged with the AF 360 and information exchanged with internal network functions. For example, the NEF 352 may translate between an AF-Service-Identifier and an internal 5GC information. NEF 352 may also receive information from other NFs based on exposed capabilities of other NFs. This information may be stored at the NEF 352 as structured data, or at a data storage NF using standardized interfaces. The stored information can then be re-exposed by the NEF 352 to other NFs and AFs, or used for other purposes such as analytics. Additionally, the NEF 352 may exhibit an Nnef service-based interface.

The NRF 354 may support service discovery functions, receive NF discovery requests from NF instances, and provide the information of the discovered NF instances to the NF instances. NRF 354 also maintains information of available NF instances and their supported services. As used herein, the terms “instantiate,” “instantiation,” and the like may refer to the creation of an instance, and an “instance” may refer to a concrete occurrence of an object, which may occur, for example, during execution of program code. Additionally, the NRF 354 may exhibit the Nnrf service-based interface.

The PCF 356 may provide policy rules to control plane functions to enforce them, and may also support unified policy framework to govern network behavior. The PCF 356 may also implement a front end to access subscription information relevant for policy decisions in a UDR of the UDM 358. In addition to communicating with functions over reference points as shown, the PCF 356 exhibit an Npcf service-based interface.

The UDM 358 may handle subscription-related information to support the network entities' handling of communication sessions, and may store subscription data of UE 302. For example, subscription data may be communicated via an N8 reference point between the UDM 358 and the AMF 344. The UDM 358 may include two parts, an application front end and a UDR. The UDR may store subscription data and policy data for the UDM 358 and the PCF 356, and/or structured data for exposure and application data (including PFDs for application detection, application request information for multiple UEs 302) for the NEF 352. The Nudr service-based interface may be exhibited by the UDR 221 to allow the UDM 358, PCF 356, and NEF 352 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 358 may exhibit the Nudm service-based interface.

The AF 360 may provide application influence on traffic routing, provide access to NEF, and interact with the policy framework for policy control.

In some embodiments, the 5GC 340 may enable edge computing by selecting operator/3rd party services to be geographically close to a point that the UE 302 is attached to the network. This may reduce latency and load on the network. To provide edge-computing implementations, the 5GC 340 may select a UPF 348 close to the UE 302 and execute traffic steering from the UPF 348 to data network 336 via the N6 interface. This may be based on the UE subscription data, UE location, and information provided by the AF 360. In this way, the AF 360 may influence UPF (re)selection and traffic routing. Based on operator deployment, when AF 360 is considered to be a trusted entity, the network operator may permit AF 360 to interact directly with relevant NFs. Additionally, the AF 360 may exhibit an Naf service-based interface.

The data network 336 may represent various network operator services, Internet access, or third party services that may be provided by one or more servers including, for example, application/content server 338.

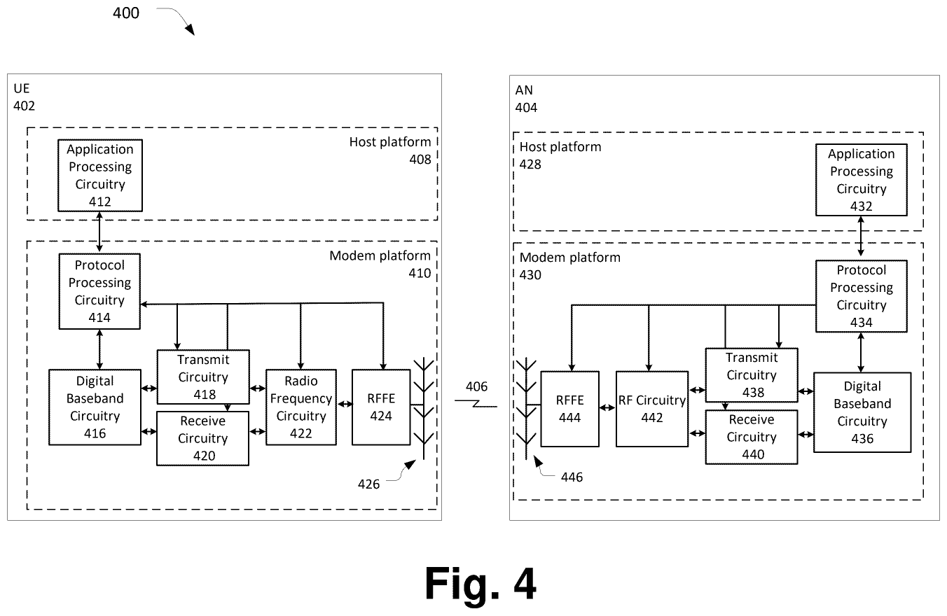

FIG. 4 schematically illustrates a wireless network 400 in accordance with various embodiments. The wireless network 400 may include a UE 402 in wireless communication with an AN 404. The UE 402 and AN 404 may be similar to, and substantially interchangeable with, like-named components described elsewhere herein.

The UE 402 may be communicatively coupled with the AN 404 via connection 406. The connection 406 is illustrated as an air interface to enable communicative coupling, and can be consistent with cellular communications protocols such as an LTE protocol or a 5G NR protocol operating at mmWave or sub-6 GHz frequencies.

The UE 402 may include a host platform 408 coupled with a modem platform 410. The host platform 408 may include application processing circuitry 412, which may be coupled with protocol processing circuitry 414 of the modem platform 410. The application processing circuitry 412 may run various applications for the UE 402 that source/sink application data. The application processing circuitry 412 may further implement one or more layer operations to transmit/receive application data to/from a data network. These layer operations may include transport (for example UDP) and Internet (for example, IP) operations

The protocol processing circuitry 414 may implement one or more of layer operations to facilitate transmission or reception of data over the connection 406. The layer operations implemented by the protocol processing circuitry 414 may include, for example, MAC, RLC, PDCP, RRC and NAS operations.

The modem platform 410 may further include digital baseband circuitry 416 that may implement one or more layer operations that are “below” layer operations performed by the protocol processing circuitry 414 in a network protocol stack. These operations may include, for example, PHY operations including one or more of HARQ-ACK functions, scrambling/descrambling, encoding/decoding, layer mapping/de-mapping, modulation symbol mapping, received symbol/bit metric determination, multi-antenna port precoding/decoding, which may include one or more of space-time, space-frequency or spatial coding, reference signal generation/detection, preamble sequence generation and/or decoding, synchronization sequence generation/detection, control channel signal blind decoding, and other related functions.

The modem platform 410 may further include transmit circuitry 418, receive circuitry 420, RF circuitry 422, and RF front end (RFFE) 424, which may include or connect to one or more antenna panels 426. Briefly, the transmit circuitry 418 may include a digital-to-analog converter, mixer, intermediate frequency (IF) components, etc.; the receive circuitry 420 may include an analog-to-digital converter, mixer, IF components, etc.; the RF circuitry 422 may include a low-noise amplifier, a power amplifier, power tracking components, etc.; RFFE 424 may include filters (for example, surface/bulk acoustic wave filters), switches, antenna tuners, beamforming components (for example, phase-array antenna components), etc. The selection and arrangement of the components of the transmit circuitry 418, receive circuitry 420, RF circuitry 422, RFFE 424, and antenna panels 426 (referred generically as “transmit/receive components”) may be specific to details of a specific implementation such as, for example, whether communication is TDM or FDM, in mmWave or sub-6 gHz frequencies, etc. In some embodiments, the transmit/receive components may be arranged in multiple parallel transmit/receive chains, may be disposed in the same or different chips/modules, etc.

In some embodiments, the protocol processing circuitry 414 may include one or more instances of control circuitry (not shown) to provide control functions for the transmit/receive components.

A UE reception may be established by and via the antenna panels 426, RFFE 424, RF circuitry 422, receive circuitry 420, digital baseband circuitry 416, and protocol processing circuitry 414. In some embodiments, the antenna panels 426 may receive a transmission from the AN 404 by receive-beamforming signals received by a plurality of antennas/antenna elements of the one or more antenna panels 426.

A UE transmission may be established by and via the protocol processing circuitry 414, digital baseband circuitry 416, transmit circuitry 418, RF circuitry 422, RFFE 424, and antenna panels 426. In some embodiments, the transmit components of the UE 404 may apply a spatial filter to the data to be transmitted to form a transmit beam emitted by the antenna elements of the antenna panels 426.

Similar to the UE 402, the AN 404 may include a host platform 428 coupled with a modem platform 430. The host platform 428 may include application processing circuitry 432 coupled with protocol processing circuitry 434 of the modem platform 430. The modem platform may further include digital baseband circuitry 436, transmit circuitry 438, receive circuitry 440, RF circuitry 442, RFFE circuitry 444, and antenna panels 446. The components of the AN 404 may be similar to and substantially interchangeable with like-named components of the UE 402. In addition to performing data transmission/reception as described above, the components of the AN 408 may perform various logical functions that include, for example, RNC functions such as radio bearer management, uplink and downlink dynamic radio resource management, and data packet scheduling.

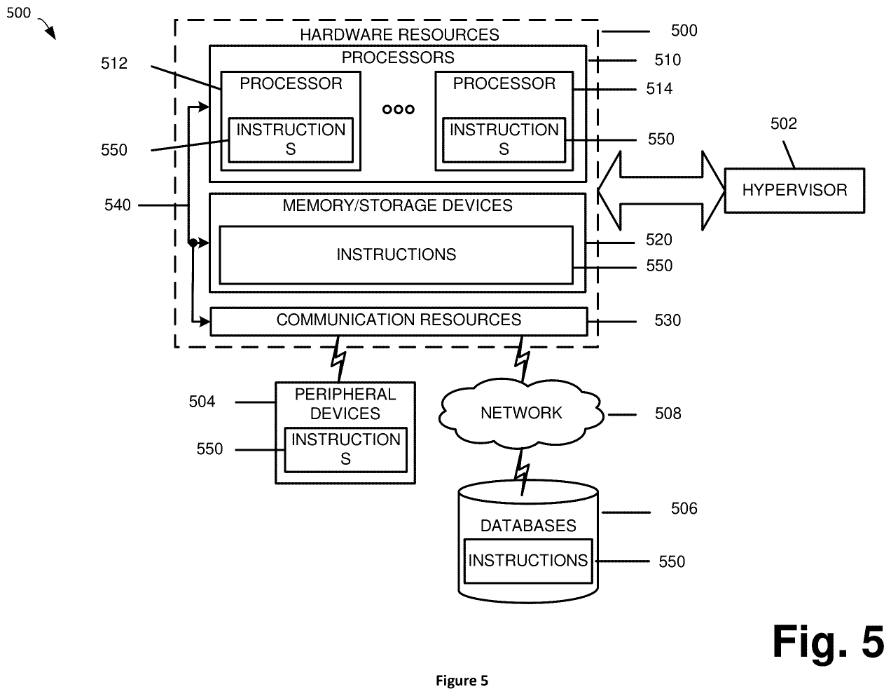

FIG. 5 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 5 shows a diagrammatic representation of hardware resources 500 including one or more processors (or processor cores) 510, one or more memory/storage devices 520, and one or more communication resources 530, each of which may be communicatively coupled via a bus 540 or other interface circuitry. For embodiments where node virtualization (e.g., NFV) is utilized, a hypervisor 502 may be executed to provide an execution environment for one or more network slices/sub-slices to utilize the hardware resources 500.

The processors 510 may include, for example, a processor 512 and a processor 514. The processors 510 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices 520 may include main memory, disk storage, or any suitable combination thereof. The memory/storage devices 520 may include, but are not limited to, any type of volatile, non-volatile, or semi-volatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 530 may include interconnection or network interface controllers, components, or other suitable devices to communicate with one or more peripheral devices 504 or one or more databases 506 or other network elements via a network 508. For example, the communication resources 530 may include wired communication components (e.g., for coupling via USB, Ethernet, etc.), cellular communication components, NFC components, Bluetooth® (or Bluetooth® Low Energy) components, Wi-Fi® components, and other communication components.

Instructions 550 may comprise software, a program, an application, an applet, an app, or other executable code for causing at least any of the processors 510 to perform any one or more of the methodologies discussed herein. The instructions 550 may reside, completely or partially, within at least one of the processors 510 (e.g., within the processor's cache memory), the memory/storage devices 520, or any suitable combination thereof. Furthermore, any portion of the instructions 550 may be transferred to the hardware resources 500 from any combination of the peripheral devices 504 or the databases 506. Accordingly, the memory of processors 510, the memory/storage devices 520, the peripheral devices 504, and the databases 506 are examples of computer-readable and machine-readable media.

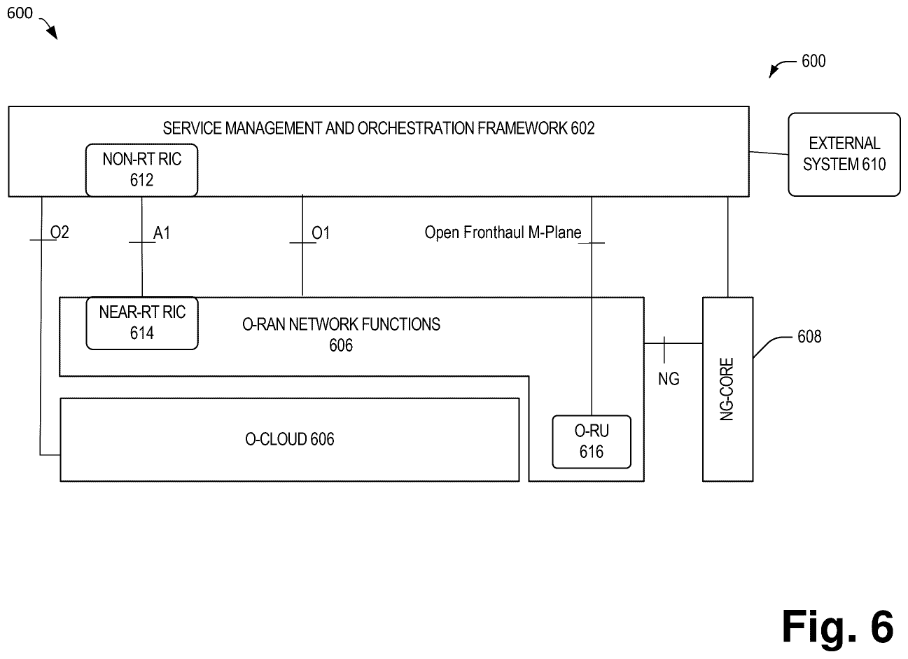

FIG. 6 provides a high-level view of an Open RAN (O-RAN) architecture 600. The O-RAN architecture 600 includes four O-RAN defined interfaces—namely, the A1 interface, the O1 interface, the O2 interface, and the Open Fronthaul Management (M)-plane interface—which connect the Service Management and Orchestration (SMO) framework 602 to O-RAN network functions (NFs) 604 and the O-Cloud 606. The SMO 602 (described in O-RAN Alliance Working Group 1, O-RAN Operations and Maintenance Interface Specification, version 2.0 (December 2019) (“0 RAN-WG1.01-Interface-v02.00”)) also connects with an external system 610, which provides data to the SMO 602. FIG. 6 also illustrates that the A1 interface terminates at an O-RAN Non-Real Time (RT) RAN Intelligent Controller (RIC) 612 in or at the SMO 602 and at the O-RAN Near-RT RIC 614 in or at the O-RAN NFs 604. The O-RAN NFs 604 can be VNFs such as VMs or containers, sitting above the O-Cloud 606 and/or Physical Network Functions (PNFs) utilizing customized hardware. All O-RAN NFs 604 are expected to support the O1 interface when interfacing the SMO framework 602. The O-RAN NFs 604 connect to the NG-Core 608 via the NG interface (which is a 3GPP defined interface). The Open Fronthaul M-plane interface between the SMO 602 and the O-RAN Radio Unit (O-RU) 616 supports the O-RU 616 management in the O-RAN hybrid model as specified in O-RAN Alliance Working Group 4, O-RAN Fronthaul Management Plane Specification, version 2.0 (July 2019) (“ORAN-WG4.MP.0-v02.00.00”). The Open Fronthaul M-plane interface is an optional interface to the SMO 602 that is included for backward compatibility purposes as per O-RAN Alliance Working Group 4, O-RAN Fronthaul Management Plane Specification, version 2.0 (July 2019) (“ORAN-WG4.MP.0-v02.00.00”), and is intended for management of the O-RU 616 in hybrid mode only. The management architecture of flat mode O-RAN Alliance Working Group 1, O-RAN Operations and Maintenance Architecture Specification, version 2.0 (December 2019) (“0 RAN-WG1.OAM-Architecture-v02.00”) and its relation to the O1 interface for the O-RU 616 is for future study. The O-RU 616 termination of the O1 interface towards the SMO 602 as specified in O-RAN Alliance Working Group 1, O-RAN Operations and Maintenance Architecture Specification, version 2.0 (December 2019) (“O RAN-WG1.OAM-Architecture-v02.00”).

FIG. 7 shows an O-RAN logical architecture 700 corresponding to the O-RAN architecture 600 of FIG. 6. In FIG. 7, the SMO 702 corresponds to the SMO 602, O-Cloud 706 corresponds to the O-Cloud 606, the non-RT RIC 712 corresponds to the non-RT RIC 612, the near-RT RIC 714 corresponds to the near-RT RIC 614, and the O-RU 716 corresponds to the O-RU 616 of FIG. 7, respectively. The O-RAN logical architecture 700 includes a radio portion and a management portion.

The management portion/side of the architectures 700 includes the SMO Framework 702 containing the non-RT RIC 712, and may include the O-Cloud 706. The O-Cloud 706 is a cloud computing platform including a collection of physical infrastructure nodes to host the relevant O-RAN functions (e.g., the near-RT RIC 714, O-CU-CP 721, O-CU-UP 722, and the O-DU 715), supporting software components (e.g., OSs, VMMs, container runtime engines, ML engines, etc.), and appropriate management and orchestration functions.

The radio portion/side of the logical architecture 700 includes the near-RT RIC 714, the O-RAN Distributed Unit (O-DU) 715, the O-RU 716, the O-RAN Central Unit-Control Plane (O-CU-CP) 721, and the O-RAN Central Unit-User Plane (O-CU-UP) 722 functions. The radio portion/side of the logical architecture 700 may also include the O-e/gNB 710.

The O-DU 715 is a logical node hosting RLC, MAC, and higher PHY layer entities/elements (High-PHY layers) based on a lower layer functional split. The O-RU 716 is a logical node hosting lower PHY layer entities/elements (Low-PHY layer) (e.g., FFT/iFFT, PRACH extraction, etc.) and RF processing elements based on a lower layer functional split. Virtualization of O-RU 716 is FFS. The O-CU-CP 721 is a logical node hosting the RRC and the control plane (CP) part of the PDCP protocol. The O O-CU-UP 722 is a logical node hosting the user plane part of the PDCP protocol and the SDAP protocol.

An E2 interface terminates at a plurality of E2 nodes. The E2 nodes are logical nodes/entities that terminate the E2 interface. For NR/5G access, the E2 nodes include the O-CU-CP 721, O-CU-UP 722, O-DU 715, or any combination of elements as defined in O-RAN Alliance Working Group 3, Near-Real-time RAN Intelligent Controller Architecture & E2 General Aspects and Principles (“ORAN-WG3.E2GAP.0-v0.1”). For E-UTRA access the E2 nodes include the O-e/gNB 710. As shown in FIG. 7, the E2 interface also connects the O-e/gNB 710 to the Near-RT RIC 714. The protocols over E2 interface are based exclusively on Control Plane (CP) protocols. The E2 functions are grouped into the following categories: (a) near-RT RIC 714 services (REPORT, INSERT, CONTROL and POLICY, as described in O-RAN Alliance Working Group 3, Near-Real-time RAN Intelligent Controller Architecture & E2 General Aspects and Principles (“ORAN-WG3.E2GAP.0-v0.1”)); and (b) near-RT RIC 714 support functions, which include E2 Interface Management (E2 Setup, E2 Reset, Reporting of General Error Situations, etc.) and Near-RT RIC Service Update (e.g., capability exchange related to the list of E2 Node functions exposed over E2).

FIG. 7 shows the Uu interface between a UE 701 and O-e/gNB 710 as well as between the UE 701 and O-RAN components. The Uu interface is a 3GPP defined interface (see e.g., sections 5.2 and 5.3 of O-RAN Alliance Working Group 4, O-RAN Fronthaul Control, User and Synchronization Plane Specification, version 2.0 (July 2019) (“ORAN-WG4.CUS.0-v02.00”)), which includes a complete protocol stack from L1 to L3 and terminates in the NG-RAN or E-UTRAN. The O-e/gNB 710 is an LTE eNB 3GPP TS 36.401 v15.1.0 (2019 Jan. 9), a 5G gNB or ng-eNB 3GPP TS 38.300 v16.0.0 (2020 Jan. 8) that supports the E2 interface. The O-e/gNB 710 may be the same or similar as eNB 312, gNB 316, ng-eNB 318, RAN 808, RAN 910, or some other base station, RAN, or nodeB discussed previously. The a UE 701 may correspond to UEs 302, 402, 802, UE 905, or some other UE discussed with respect to other Figures herein, and/or the like. There may be multiple UEs 701 and/or multiple O-e/gNB 710, each of which may be connected to one another the via respective Uu interfaces. Although not shown in FIG. 7, the O-e/gNB 710 supports O-DU 715 and O-RU 716 functions with an Open Fronthaul interface between them.

The Open Fronthaul (OF) interface(s) is/are between O-DU 715 and O-RU 716 functions O-RAN Alliance Working Group 4, O-RAN Fronthaul Management Plane Specification, version 2.0 (July 2019) (“ORAN-WG4.MP.0-v02.00.00”) O-RAN Alliance Working Group 4, O-RAN Fronthaul Control, User and Synchronization Plane Specification, version 2.0 (July 2019) (“ORAN-WG4.CUS.0-v02.00”). The OF interface(s) includes the Control User Synchronization (CUS) Plane and Management (M) Plane. FIGS. 6 and 7 also show that the O-RU 716 terminates the OF M-Plane interface towards the O-DU 715 and optionally towards the SMO 702 as specified in O-RAN Alliance Working Group 4, O-RAN Fronthaul Management Plane Specification, version 2.0 (July 2019) (“ORAN-WG4.MP.0-v02.00.00”). The O-RU 716 terminates the OF CUS-Plane interface towards the O-DU 715 and the SMO 702.

The F1-c interface connects the O-CU-CP 721 with the O-DU 715. As defined by 3GPP, the F1-c interface is between the gNB-CU-CP and gNB-DU nodes O-RAN Alliance Working Group 4, O-RAN Fronthaul Control, User and Synchronization Plane Specification, version 2.0 (July 2019) (“ORAN-WG4.CUS.0-v02.00”) and 3GPP TS 38.470 v16.0.0 (2020 Jan. 9). However, for purposes of O-RAN, the F1-c interface is adopted between the O-CU-CP 721 with the O-DU 715 functions while reusing the principles and protocol stack defined by 3GPP and the definition of interoperability profile specifications.

The F1-u interface connects the O-CU-UP 722 with the O-DU 715. As defined by 3GPP, the F1-u interface is between the gNB-CU-UP and gNB-DU nodes O-RAN Alliance Working Group 4, O-RAN Fronthaul Control, User and Synchronization Plane Specification, version 2.0 (July 2019) (“ORAN-WG4.CUS.0-v02.00”) and 3GPP TS 38.470 v16.0.0 (2020 Jan. 9). However, for purposes of O-RAN, the F1-u interface is adopted between the O-CU-UP 722 with the O-DU 715 functions while reusing the principles and protocol stack defined by 3GPP and the definition of interoperability profile specifications.

The NG-c interface is defined by 3GPP as an interface between the gNB-CU-CP and the AMF in the 5GC 3GPP TS 38.300 v16.0.0 (2020 Jan. 8). The NG-c is also referred as the N2 interface (see 3GPP TS 38.300 v16.0.0 (2020 Jan. 8)). The NG-u interface is defined by 3GPP, as an interface between the gNB-CU-UP and the UPF in the 5GC 3GPP TS 38.300 v16.0.0 (2020 Jan. 8). The NG-u interface is referred as the N3 interface (see 3GPP TS 38.300 v16.0.0 (2020 Jan. 8)). In O-RAN, NG-c and NG-u protocol stacks defined by 3GPP are reused and may be adapted for O-RAN purposes.

The X2-c interface is defined in 3GPP for transmitting control plane information between eNBs or between eNB and en-gNB in EN-DC. The X2-u interface is defined in 3GPP for transmitting user plane information between eNBs or between eNB and en-gNB in EN-DC (see e.g., [005], 3GPP TS 38.300 v16.0.0 (2020 Jan. 8)). In O-RAN, X2-c and X2-u protocol stacks defined by 3GPP are reused and may be adapted for O-RAN purposes

The Xn-c interface is defined in 3GPP for transmitting control plane information between gNBs, ng-eNBs, or between an ng-eNB and gNB. The Xn-u interface is defined in 3GPP for transmitting user plane information between gNBs, ng-eNBs, or between ng-eNB and gNB (see e.g., 3GPP TS 38.300 v16.0.0 (2020 Jan. 8), 3GPP TS 38.420 v15.2.0 (2019 Jan. 8)). In O-RAN, Xn-c and Xn-u protocol stacks defined by 3GPP are reused and may be adapted for O-RAN purposes

The E1 interface is defined by 3GPP as being an interface between the gNB-CU-CP (e.g., gNB-CU-CP 3728) and gNB-CU-UP (see e.g., O-RAN Alliance Working Group 4, O-RAN Fronthaul Control, User and Synchronization Plane Specification, version 2.0 (July 2019) (“ORAN-WG4.CUS.0-v02.00”), 3GPP TS 38.460 v16.0.0 (2020 Jan. 9)). In O-RAN, E1 protocol stacks defined by 3GPP are reused and adapted as being an interface between the O-CU-CP 721 and the O-CU-UP 722 functions.

The O-RAN Non-Real Time (RT) RAN Intelligent Controller (RIC) 712 is a logical function within the SMO framework 602, 702 that enables non-real-time control and optimization of RAN elements and resources; AI/machine learning (ML) workflow(s) including model training, inferences, and updates; and policy-based guidance of applications/features in the Near-RT RIC 714.

The O-RAN near-RT RIC 714 is a logical function that enables near-real-time control and optimization of RAN elements and resources via fine-grained data collection and actions over the E2 interface. The near-RT RIC 714 may include one or more AI/ML workflows including model training, inferences, and updates.

The non-RT RIC 712 can be an ML training host to host the training of one or more ML models. ML training can be performed offline using data collected from the RIC, O-DU 715 and O-RU 716. For supervised learning, non-RT RIC 712 is part of the SMO 702, and the ML training host and/or ML model host/actor can be part of the non-RT RIC 712 and/or the near-RT RIC 714. For unsupervised learning, the ML training host and ML model host/actor can be part of the non-RT RIC 712 and/or the near-RT RIC 714. For reinforcement learning, the ML training host and ML model host/actor may be co-located as part of the non-RT RIC 712 and/or the near-RT RIC 714. In some implementations, the non-RT RIC 712 may request or trigger ML model training in the training hosts regardless of where the model is deployed and executed. ML models may be trained and not currently deployed.

In some implementations, the non-RT RIC 712 provides a query-able catalog for an ML designer/developer to publish/install trained ML models (e.g., executable software components). In these implementations, the non-RT RIC 712 may provide discovery mechanism if a particular ML model can be executed in a target ML inference host (MF), and what number and type of ML models can be executed in the MF. For example, there may be three types of ML catalogs made discoverable by the non-RT RIC 712: a design-time catalog (e.g., residing outside the non-RT RIC 712 and hosted by some other ML platform(s)), a training/deployment-time catalog (e.g., residing inside the non-RT RIC 712), and a run-time catalog (e.g., residing inside the non-RT RIC 712). The non-RT RIC 712 supports necessary capabilities for ML model inference in support of ML assisted solutions running in the non-RT RIC 712 or some other ML inference host. These capabilities enable executable software to be installed such as VMs, containers, etc. The non-RT RIC 712 may also include and/or operate one or more ML engines, which are packaged software executable libraries that provide methods, routines, data types, etc., used to run ML models. The non-RT RIC 712 may also implement policies to switch and activate ML model instances under different operating conditions.

The non-RT RIC 72 is be able to access feedback data (e.g., FM and PM statistics) over the O1 interface on ML model performance and perform necessary evaluations. If the ML model fails during runtime, an alarm can be generated as feedback to the non-RT RIC 712. How well the ML model is performing in terms of prediction accuracy or other operating statistics it produces can also be sent to the non-RT RIC 712 over 01. The non-RT RIC 712 can also scale ML model instances running in a target MF over the O1 interface by observing resource utilization in MF. The environment where the ML model instance is running (e.g., the MF) monitors resource utilization of the running ML model. This can be done, for example, using an ORAN-SC component called ResourceMonitor in the near-RT RIC 714 and/or in the non-RT RIC 712, which continuously monitors resource utilization. If resources are low or fall below a certain threshold, the runtime environment in the near-RT RIC 714 and/or the non-RT RIC 712 provides a scaling mechanism to add more ML instances. The scaling mechanism may include a scaling factor such as an number, percentage, and/or other like data used to scale up/down the number of ML instances. ML model instances running in the target ML inference hosts may be automatically scaled by observing resource utilization in the MF. For example, the Kubernetes® (K8s) runtime environment typically provides an auto-scaling feature.

The A1 interface is between the non-RT RIC 712 (within or outside the SMO 702) and the near-RT RIC 714. The A1 interface supports three types of services as defined in O-RAN Alliance Working Group 2, O-RAN A1 interface: General Aspects and Principles Specification, version 1.0 (October 2019) (“ORAN-WG2.A1.GA&P-v01.00”), including a Policy Management Service, an Enrichment Information Service, and ML Model Management Service. A1 policies have the following characteristics compared to persistent configuration O-RAN Alliance Working Group 2, O-RAN A1 interface: General Aspects and Principles Specification, version 1.0 (October 2019) (“ORAN-WG2.A1.GA&P-v01.00”): A1 policies are not critical to traffic; A1 policies have temporary validity; A1 policies may handle individual UE or dynamically defined groups of UEs; A1 policies act within and take precedence over the configuration; and A1 policies are non-persistent, i.e., do not survive a restart of the near-RT RIC.

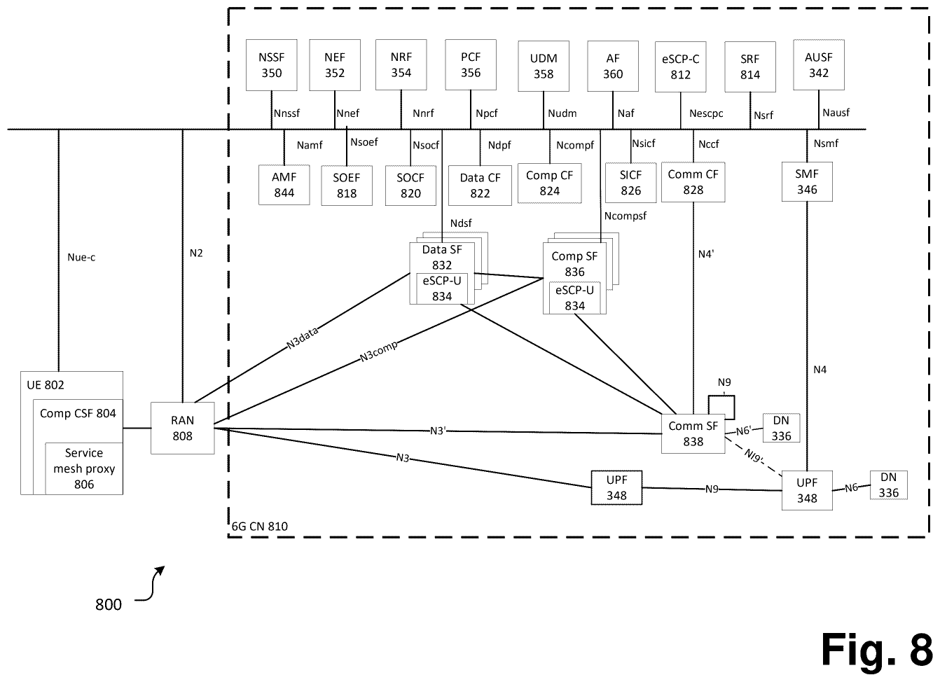

FIG. 8 illustrates a network 800 in accordance with various embodiments. The network 800 may operate in a matter consistent with 3GPP technical specifications or technical reports for 6G systems. In some embodiments, the network 800 may operate concurrently with network 300. For example, in some embodiments, the network 800 may share one or more frequency or bandwidth resources with network 300. As one specific example, a UE (e.g., UE 802) may be configured to operate in both network 800 and network 300. Such configuration may be based on a UE including circuitry configured for communication with frequency and bandwidth resources of both networks 300 and 800. In general, several elements of network 800 may share one or more characteristics with elements of network 300. For the sake of brevity and clarity, such elements may not be repeated in the description of network 800.

The network 800 may include a UE 802, which may include any mobile or non-mobile computing device designed to communicate with a RAN 808 via an over-the-air connection. The UE 802 may be similar to, for example, UE 302. The UE 802 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

Although not specifically shown in FIG. 8, in some embodiments the network 800 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc. Similarly, although not specifically shown in FIG. 8, the UE 802 may be communicatively coupled with an AP such as AP 306 as described with respect to FIG. 3. Additionally, although not specifically shown in FIG. 8, in some embodiments the RAN 808 may include one or more ANss such as AN 308 as described with respect to FIG. 3. The RAN 808 and/or the AN of the RAN 808 may be referred to as a base station (BS), a RAN node, or using some other term or name.

The UE 802 and the RAN 808 may be configured to communicate via an air interface that may be referred to as a sixth generation (6G) air interface. The 6G air interface may include one or more features such as communication in a terahertz (THz) or sub-THz bandwidth, or joint communication and sensing. As used herein, the term “joint communication and sensing” may refer to a system that allows for wireless communication as well as radar-based sensing via various types of multiplexing. As used herein, THz or sub-THz bandwidths may refer to communication in the 80 GHz and above frequency ranges. Such frequency ranges may additionally or alternatively be referred to as “millimeter wave” or “mmWave” frequency ranges.

The RAN 808 may allow for communication between the UE 802 and a 6G core network (CN) 810. Specifically, the RAN 808 may facilitate the transmission and reception of data between the UE 802 and the 6G CN 810. The 6G CN 810 may include various functions such as NSSF 350, NEF 352, NRF 354, PCF 356, UDM 358, AF 360, SMF 346, and AUSF 342. The 6G CN 810 may additional include UPF 348 and DN 336 as shown in FIG. 8.

Additionally, the RAN 808 may include various additional functions that are in addition to, or alternative to, functions of a legacy cellular network such as a 4G or 5G network. Two such functions may include a Compute Control Function (Comp CF) 824 and a Compute Service Function (Comp SF) 836. The Comp CF 824 and the Comp SF 836 may be parts or functions of the Computing Service Plane. Comp CF 824 may be a control plane function that provides functionalities such as management of the Comp SF 836, computing task context generation and management (e.g., create, read, modify, delete), interaction with the underlying computing infrastructure for computing resource management, etc. Comp SF 836 may be a user plane function that serves as the gateway to interface computing service users (such as UE 802) and computing nodes behind a Comp SF instance. Some functionalities of the Comp SF 836 may include: parse computing service data received from users to compute tasks executable by computing nodes; hold service mesh ingress gateway or service API gateway; service and charging policies enforcement; performance monitoring and telemetry collection, etc. In some embodiments, a Comp SF 836 instance may serve as the user plane gateway for a cluster of computing nodes. A Comp CF 824 instance may control one or more Comp SF 836 instances.

Two other such functions may include a Communication Control Function (Comm CF) 828 and a Communication Service Function (Comm SF) 838, which may be parts of the Communication Service Plane. The Comm CF 828 may be the control plane function for managing the Comm SF 838, communication sessions creation/configuration/releasing, and managing communication session context. The Comm SF 838 may be a user plane function for data transport. Comm CF 828 and Comm SF 838 may be considered as upgrades of SMF 346 and UPF 348, which were described with respect to a 5G system in FIG. 3. The upgrades provided by the Comm CF 828 and the Comm SF 838 may enable service-aware transport. For legacy (e.g., 4G or 5G) data transport, SMF 346 and UPF 348 may still be used.

Two other such functions may include a Data Control Function (Data CF) 822 and Data Service Function (Data SF) 832 may be parts of the Data Service Plane. Data CF 822 may be a control plane function and provides functionalities such as Data SF 832 management, Data service creation/configuration/releasing, Data service context management, etc. Data SF 832 may be a user plane function and serve as the gateway between data service users (such as UE 802 and the various functions of the 6G CN 810) and data service endpoints behind the gateway. Specific functionalities may include include: parse data service user data and forward to corresponding data service endpoints, generate charging data, report data service status.

Another such function may be the Service Orchestration and Chaining Function (SOCF) 820, which may discover, orchestrate and chain up communication/computing/data services provided by functions in the network. Upon receiving service requests from users, SOCF 820 may interact with one or more of Comp CF 824, Comm CF 828, and Data CF 822 to identify Comp SF 836, Comm SF 838, and Data SF 832 instances, configure service resources, and generate the service chain, which could contain multiple Comp SF 836, Comm SF 838, and Data SF 832 instances and their associated computing endpoints. Workload processing and data movement may then be conducted within the generated service chain. The SOCF 820 may also responsible for maintaining, updating, and releasing a created service chain.

Another such function may be the service registration function (SRF) 814, which may act as a registry for system services provided in the user plane such as services provided by service endpoints behind Comp SF 836 and Data SF 832 gateways and services provided by the UE 802. The SRF 814 may be considered a counterpart of NRF 354, which may act as the registry for network functions.

Other such functions may include an evolved service communication proxy (eSCP) and service infrastructure control function (SICF) 826, which may provide service communication infrastructure for control plane services and user plane services. The eSCP may be related to the service communication proxy (SCP) of 5G with user plane service communication proxy capabilities being added. The eSCP is therefore expressed in two parts: eCSP-C 812 and eSCP-U 834, for control plane service communication proxy and user plane service communication proxy, respectively. The SICF 826 may control and configure eCSP instances in terms of service traffic routing policies, access rules, load balancing configurations, performance monitoring, etc.

Another such function is the AMF 844. The AMF 844 may be similar to 344, but with additional functionality. Specifically, the AMF 844 may include potential functional repartition, such as move the message forwarding functionality from the AMF 844 to the RAN 808.

Another such function is the service orchestration exposure function (SOEF) 818. The SOEF may be configured to expose service orchestration and chaining services to external users such as applications.

The UE 802 may include an additional function that is referred to as a computing client service function (comp CSF) 804. The comp CSF 804 may have both the control plane functionalities and user plane functionalities, and may interact with corresponding network side functions such as SOCF 820, Comp CF 824, Comp SF 836, Data CF 822, and/or Data SF 832 for service discovery, request/response, compute task workload exchange, etc. The Comp CSF 804 may also work with network side functions to decide on whether a computing task should be run on the UE 802, the RAN 808, and/or an element of the 6G CN 810.

The UE 802 and/or the Comp CSF 804 may include a service mesh proxy 806. The service mesh proxy 806 may act as a proxy for service-to-service communication in the user plane. Capabilities of the service mesh proxy 806 may include one or more of addressing, security, load balancing, etc.

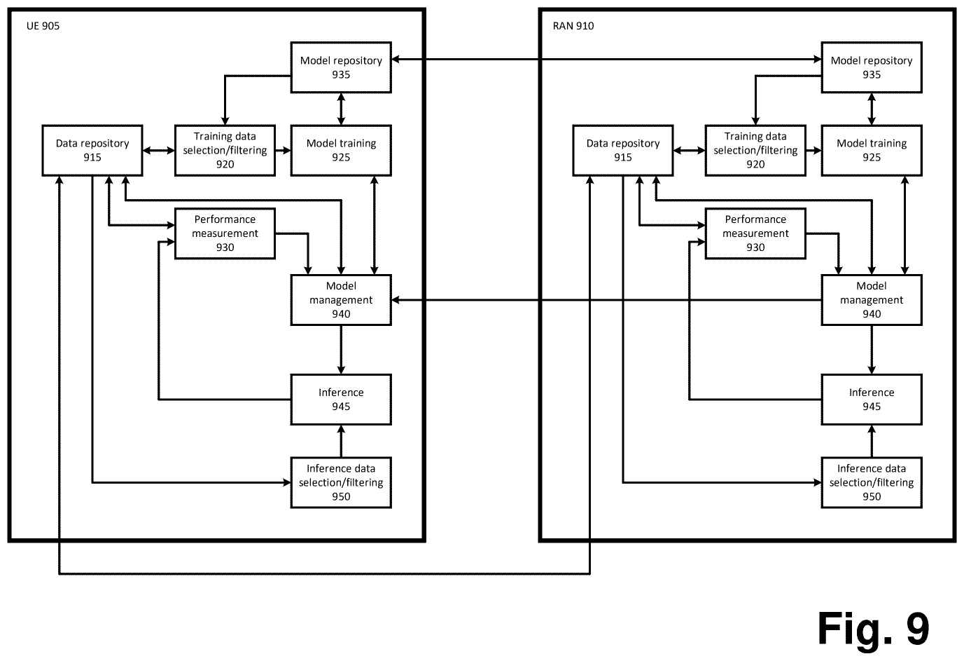

FIG. 9 illustrates a simplified block diagram of artificial (AI)-assisted communication between a UE 905 and a RAN 910, in accordance with various embodiments. More specifically, as described in further detail below, AI/machine learning (ML) models may be used or leveraged to facilitate over-the-air communication between UE 905 and RAN 910.

One or both of the UE 905 and the RAN 910 may operate in a matter consistent with 3GPP technical specifications or technical reports for 6G systems. In some embodiments, the wireless cellular communication between the UE 905 and the RAN 910 may be part of, or operate concurrently with, networks 800, 300, and/or some other network described herein.

The UE 905 may be similar to, and share one or more features with, UE 802, UE 302, and/or some other UE described herein. The UE 905 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc. The RAN 910 may be similar to, and share one or more features with, RAN 314, RAN 808, and/or some other RAN described herein.

As may be seen in FIG. 9, the A1-related elements of UE 905 may be similar to the A1-related elements of RAN 910. For the sake of discussion herein, description of the various elements will be provided from the point of view of the UE 905, however it will be understood that such discussion or description will apply to equally named/numbered elements of RAN 910, unless explicitly stated otherwise.

As previously noted, the UE 905 may include various elements or functions that are related to AI/ML. Such elements may be implemented as hardware, software, firmware, and/or some combination thereof. In embodiments, one or more of the elements may be implemented as part of the same hardware (e.g., chip or multi-processor chip), software (e.g., a computing program), or firmware as another element.

One such element may be a data repository 915. The data repository 915 may be responsible for data collection and storage. Specifically, the data repository 915 may collect and store RAN configuration parameters, measurement data, performance key performance indicators (KPIs), model performance metrics, etc., for model training, update, and inference. More generally, collected data is stored into the repository. Stored data can be discovered and extracted by other elements from the data repository 915. For example, as may be seen, the inference data selection/filter element 950 may retrieve data from the data repository 915. In various embodiments, the UE 905 may be configured to discover and request data from the data repository 910 in the RAN, and vice versa. More generally, the data repository 915 of the UE 905 may be communicatively coupled with the data repository 915 of the RAN 910 such that the respective data repositories of the UE and the RAN may share collected data with one another.

Another such element may be a training data selection/filtering functional block 920. The training data selection/filter functional block 920 may be configured to generate training, validation, and testing datasets for model training. Training data may be extracted from the data repository 915. Data may be selected/filtered based on the specific AI/ML model to be trained. Data may optionally be transformed/augmented/pre-processed (e.g., normalized) before being loaded into datasets. The training data selection/filter functional block 920 may label data in datasets for supervised learning. The produced datasets may then be fed into model training the model training functional block 925.

As noted above, another such element may be the model training functional block 925. This functional block may be responsible for training and updating(re-training) AI/ML models. The selected model may be trained using the fed-in datasets (including training, validation, testing) from the training data selection/filtering functional block. The model training functional block 925 may produce trained and tested AI/ML models which are ready for deployment. The produced trained and tested models can be stored in a model repository 935.

The model repository 935 may be responsible for AI/ML models' (both trained and un-trained) storage and exposure. Trained/updated model(s) may be stored into the model repository 935. Model and model parameters may be discovered and requested by other functional blocks (e.g., the training data selection/filter functional block 920 and/or the model training functional block 925). In some embodiments, the UE 905 may discover and request AI/ML models from the model repository 935 of the RAN 910. Similarly, the RAN 910 may be able to discover and/or request AI/ML models from the model repository 935 of the UE 905. In some embodiments, the RAN 910 may configure models and/or model parameters in the model repository 935 of the UE 905.

Another such element may be a model management functional block 940. The model management functional block 940 may be responsible for management of the AI/ML model produced by the model training functional block 925. Such management functions may include deployment of a trained model, monitoring model performance, etc. In model deployment, the model management functional block 940 may allocate and schedule hardware and/or software resources for inference, based on received trained and tested models. As used herein, “inference” refers to the process of using trained AI/ML model(s) to generate data analytics, actions, policies, etc. based on input inference data. In performance monitoring, based on wireless performance KPIs and model performance metrics, the model management functional block 940 may decide to terminate the running model, start model re-training, select another model, etc. In embodiments, the model management functional block 940 of the RAN 910 may be able to configure model management policies in the UE 905 as shown.

Another such element may be an inference data selection/filtering functional block 950. The inference data selection/filter functional block 950 may be responsible for generating datasets for model inference at the inference functional block 945, as described below. Specifically, inference data may be extracted from the data repository 915. The inference data selection/filter functional block 950 may select and/or filter the data based on the deployed AI/ML model. Data may be transformed/augmented/pre-processed following the same transformation/augmentation/pre-processing as those in training data selection/filtering as described with respect to functional block 920. The produced inference dataset may be fed into the inference functional block 945.

Another such element may be the inference functional block 945. The inference functional block 945 may be responsible for executing inference as described above. Specifically, the inference functional block 945 may consume the inference dataset provided by the inference data selection/filtering functional block 950, and generate one or more outcomes. Such outcomes may be or include data analytics, actions, policies, etc. The outcome(s) may be provided to the performance measurement functional block 930. The performance measurement functional block 930 may be configured to measure model performance metrics (e.g., accuracy, model bias, run-time latency, etc.) of deployed and executing models based on the inference outcome(s) for monitoring purpose. Model performance data may be stored in the data repository 915.

### Some Definitions

For the purposes of the present document, the following terms and definitions are applicable to the examples and embodiments discussed herein.

The term “application” may refer to a complete and deployable package, environment to achieve a certain function in an operational environment. The term “AI/ML application” or the like may be an application that contains some AI/ML models and application-level descriptions.

The term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, and/or transferring digital data. Processing circuitry may include one or more processing cores to execute instructions and one or more memory structures to store program and data information. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes. Processing circuitry may include more hardware accelerators, which may be microprocessors, programmable processing devices, or the like. The one or more hardware accelerators may include, for example, computer vision (CV) and/or deep learning (DL) accelerators. The terms “application circuitry” and/or “baseband circuitry” may be considered synonymous to, and may be referred to as, “processor circuitry.”

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, and/or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “network element” as used herein refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, RAN device, RAN node, gateway, server, virtualized VNF, NFVI, and/or the like.

The term “computer system” as used herein refers to any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configured to share computing and/or networking resources.

The term “appliance,” “computer appliance,” or the like, as used herein refers to a computer device or computer system with program code (e.g., software or firmware) that is specifically designed to provide a specific computing resource. A “virtual appliance” is a virtual machine image to be implemented by a hypervisor-equipped device that virtualizes or emulates a computer appliance or otherwise is dedicated to provide a specific computing resource.

The term “resource” as used herein refers to a physical or virtual device, a physical or virtual component within a computing environment, and/or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, and/or the like. A “hardware resource” may refer to compute, storage, and/or network resources provided by physical hardware element(s). A “virtualized resource” may refer to compute, storage, and/or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” as used herein refers to a connection between two devices through a RAT for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or link, and/or the like.

The term “information element” refers to a structural element containing one or more fields. The term “field” refers to individual contents of an information element, or a data element that contains content.

The term “SMTC” refers to an SSB-based measurement timing configuration configured by SSB-MeasurementTimingConfiguration.

The term “SSB” refers to an SS/PBCH block.

The term “a “Primary Cell” refers to the MCG cell, operating on the primary frequency, in which the UE either performs the initial connection establishment procedure or initiates the connection re-establishment procedure.

The term “Primary SCG Cell” refers to the SCG cell in which the UE performs random access when performing the Reconfiguration with Sync procedure for DC operation.

The term “Secondary Cell” refers to a cell providing additional radio resources on top of a Special Cell for a UE configured with CA.

The term “Secondary Cell Group” refers to the subset of serving cells comprising the PSCell and zero or more secondary cells for a UE configured with DC.

The term “Serving Cell” refers to the primary cell for a UE in RRC_CONNECTED not configured with CA/DC there is only one serving cell comprising of the primary cell.

The term “serving cell” or “serving cells” refers to the set of cells comprising the Special Cell(s) and all secondary cells for a UE in RRC_CONNECTED configured with CA/.

The term “Special Cell” refers to the PCell of the MCG or the PSCell of the SCG for DC operation; otherwise, the term “Special Cell” refers to the Pcell.

The term “machine learning” or “ML” refers to the use of computer systems implementing algorithms and/or statistical models to perform specific task(s) without using explicit instructions, but instead relying on patterns and inferences. ML algorithms build or estimate mathematical model(s) (referred to as “ML models” or the like) based on sample data (referred to as “training data,” “model training information,” or the like) in order to make predictions or decisions without being explicitly programmed to perform such tasks. Generally, an ML algorithm is a computer program that learns from experience with respect to some task and some performance measure, and an ML model may be any object or data structure created after an ML algorithm is trained with one or more training datasets. After training, an ML model may be used to make predictions on new datasets. Although the term “ML algorithm” refers to different concepts than the term “ML model,” these terms as discussed herein may be used interchangeably for the purposes of the present disclosure.

The term “machine learning model,” “ML model,” or the like may also refer to ML methods and concepts used by an ML-assisted solution. An “ML-assisted solution” is a solution that addresses a specific use case using ML algorithms during operation. ML models include supervised learning (e.g., linear regression, k-nearest neighbor (KNN), descision tree algorithms, support machine vectors, Bayesian algorithm, ensemble algorithms, etc.) unsupervised learning (e.g., K-means clustering, principle component analysis (PCA), etc.), reinforcement learning (e.g., Q-learning, multi-armed bandit learning, deep RL, etc.), neural networks, and the like.

Depending on the implementation a specific ML model could have many sub-models as components and the ML model may train all sub-models together. Separately trained ML models can also be chained together in an ML pipeline during inference. An “ML pipeline” is a set of functionalities, functions, or functional entities specific for an ML-assisted solution; an ML pipeline may include one or several data sources in a data pipeline, a model training pipeline, a model evaluation pipeline, and an actor. The “actor” is an entity that hosts an ML assisted solution using the output of the ML model inference). The term “ML training host” refers to an entity, such as a network function, that hosts the training of the model. The term “ML inference host” refers to an entity, such as a network function, that hosts model during inference mode (which includes both the model execution as well as any online learning if applicable). The ML-host informs the actor about the output of the ML algorithm, and the actor takes a decision for an action (an “action” is performed by an actor as a result of the output of an ML assisted solution). The term “model inference information” refers to information used as an input to the ML model for determining inference(s); the data used to train an ML model and the data used to determine inferences may overlap, however, “training data” and “inference data” refer to different concepts.

### EXAMPLES

Additional examples of the presently described method, system, and device embodiments include the following, non-limiting implementations. Each of the following non-limiting examples may stand on its own or may be combined in any permutation or combination with any one or more of the other examples provided below or throughout the present disclosure.

Example 1 includes an apparatus to implement an E2 node in a radio-access network (RAN) of an Open Radio Access Network (O-RAN), the apparatus comprising processing circuitry, and a radio frequency (RF) interface to couple the processing circuitry to an RF circuitry, the processing circuitry to: determine a Near-Real-Time RAN-Intelligent-Controller (Near-RT RIC) communication from an E2 interface, the Near RT RIC communication including a cell-level energy-saving configuration information element (O-CellDTXDRX-Config IE); configure a discontinuous transmission or reception (DTX/DRX) operation of the RAN in a cell of the RAN based on the O-CellDTXDRX-Config IE: and cause the RAN's DTX/DRX operation based on the O-CellDTXDRX-Config IE.

Example 2 includes the subject matter of Example 1, wherein the O-CellDTXDRX-Config IE includes an onDurationTimer information element (IE), the processing circuitry to further configure the RAN based on the onDurationTimer IE to control a length of time that the cell remains in an active state during a DTX or DRX cycle.

Example 3 includes the subject matter of Example 2, wherein the OnDurationTimer IE is expressed in either submilliseconds or milliseconds, wherein a submillisecond field of the OnDuration Timer IE is to be represented as an integer ranging from 1 to 31, with values in multiples of 1/32 ms, and a millisecond field of the OnDuration Timer IE is to be represented as an enumerated value selected from a set of predefined durations in milliseconds.

Example 4 includes the subject matter of Example 1, wherein the O-CellDTXDRX-Config IE includes a cycleStartOffset information element (IE), the processing circuitry to further configure the RAN based on the cycleStartOffset IE to control both a repetition interval and a starting point within an interval for a DTX or DRX cycle for the cell.

Example 5 includes the subject matter of Example 4, wherein the cycleStartOffset IE is based on: a periodicity based on predefined periodicities corresponding to cycle durations in milliseconds: and an integer offset value in milliseconds, to indicate a starting point of the DTX or DRX cycle within the periodicity.

Example 6 includes the subject matter of Example 4, wherein the cycleStartOffset IE includes: a periodicity field comprising an enumerated value indicating a duration of the DTX or DRX cycle: and an offset field comprising an integer value, in milliseconds, to define a timing offset for the starting point of the DTX or DRX cycle within a selected periodicity as indicated in the periodicity field, wherein the integer value of the offset field ranges from 0 ms up to 10239 ms.

Example 7 includes the subject matter of Example 6, wherein the enumerated value is one of 10 ms, 20 ms, 32 ms, 40 ms, 60 ms, 64 ms, 70 ms, 80 ms, 128 ms, 160 ms, 256 ms, 320 ms, 512 ms, 640 ms, 1024 ms, 1280 ms, 2048 ms, 2560 ms, 5120 ms, or 10240 ms and the integer value is based on the enumerated value.

Example 8 includes the subject matter of Example 7, wherein the integer value is based on the enumerated value.

Example 9 includes the subject matter of Example 1, wherein the O-CellDTXDRX-Config IE includes a slotOffset information element (IE), the processing circuitry to further configure the RAN based on the slotOffset IE to align a start of active durations within a subframe in increments of 1/32 ms.

Example 10 includes the subject matter of Example 1, wherein the O-CellDTXDRX-Config IE includes a configType information element (IE), the processing circuitry to further configure the RAN based on the configType IE to select whether the cell operates in DTX mode, DRX mode, or combined DTX and DRX mode.

Example 11 includes the subject matter of Example 1, wherein the O-CellDTXDRX-Config IE includes an activationStatus information element (IE), the processing circuitry to further configure the RAN based on the activationStatus IE to enable or disable activation of a DTX or DRX configuration for the cell.

Example 12 includes the subject matter of Example 1, wherein the O-CellDTXDRX-Config IE includes an I1Activation information element (IE), the processing circuitry to further configure the RAN based on the I1Activation IE to enable or disable Layer 1 (L1) signaling via Downlink Control Information (DCI) Format 2_9, to dynamically activate or dynamically deactivate a DTX or DRX configuration for the cell.

Example 13 includes one or more tangible non-transitory machine readable storage media storing instructions that, when executed at an apparatus to implement an E2 node in a radio-access network (RAN) of an Open Radio Access Network (O-RAN), causes the apparatus to perform operations including: determining a Near-Real-Time RAN-Intelligent-Controller (Near-RT RIC) communication from an E2 interface, the Near RT RIC communication including a cell-level energy-saving configuration information element (O-CellDTXDRX-Config IE); configuring a discontinuous transmission or reception (DTX/DRX) operation of the RAN in a cell of the RAN based on the O-CellDTXDRX-Config IE: and causing the RAN's DTX/DRX operation based on the O-CellDTXDRX-Config IE.

Example 14 includes the subject matter of Example 13, wherein the O-CelIDTXDRX-Config IE includes an onDurationTimer information element (IE), the operations further including configuring the RAN based on the onDurationTimer IE to control a length of time that the cell remains in an active state during a DTX or DRX cycle.

Example 15 includes the subject matter of Example 14, wherein the OnDurationTimer IE is expressed in either submilliseconds or milliseconds, wherein a submillisecond field of the OnDuration Timer IE is to be represented as an integer ranging from 1 to 31, with values in multiples of 1/32 ms, and a millisecond field of the OnDuration Timer IE is to be represented as an enumerated value selected from a set of predefined durations in milliseconds.

Example 16 includes the subject matter of Example 13, wherein the O-CelIDTXDRX-Config IE includes a cycleStartOffset information element (IE), the operations further including configuring the RAN based on the cycleStartOffset IE to control both a repetition interval and a starting point within an interval for a DTX or DRX cycle for the cell.

Example 17 includes the subject matter of Example 16, wherein the cycleStartOffset IE is based on: a periodicity based on predefined periodicities corresponding to cycle durations in milliseconds: and an integer offset value in milliseconds, to indicate a starting point of the DTX or DRX cycle within the periodicity.

Example 18 includes the subject matter of Example 16, wherein the cycleStartOffset IE includes: a periodicity field comprising an enumerated value indicating a duration of the DTX or DRX cycle: and an offset field comprising an integer value, in milliseconds, to define a timing offset for the starting point of the DTX or DRX cycle within a selected periodicity as indicated in the periodicity field, wherein the integer value of the offset field ranges from 0 ms up to 10239 ms.

Example 19 includes the subject matter of Example 18, wherein the enumerated value is one of 10 ms, 20 ms, 32 ms, 40 ms, 60 ms, 64 ms, 70 ms, 80 ms, 128 ms, 160 ms, 256 ms, 320 ms, 512 ms, 640 ms, 1024 ms, 1280 ms, 2048 ms, 2560 ms, 5120 ms, or 10240 ms and the integer value is based on the enumerated value.

Example 20 includes the subject matter of Example 19, wherein the integer value is based on the enumerated value.

Example 21 includes the subject matter of Example 13, wherein the O-CelIDTXDRX-Config IE includes a slotOffset information element (IE), the operations further including configuring the RAN based on the slotOffset IE to align a start of active durations within a subframe in increments of 1/32 ms.

Example 22 includes the subject matter of Example 13, wherein the O-CelIDTXDRX-Config IE includes a configType information element (IE), the operations further including configuring the RAN based on the configType IE to select whether the cell operates in DTX mode, DRX mode, or combined DTX and DRX mode.

Example 23 includes the subject matter of Example 13, wherein the O-CelIDTXDRX-Config IE includes an activationStatus information element (IE), the operations further including configuring the RAN based on the activationStatus IE to enable or disable activation of a DTX or DRX configuration for the cell.

Example 24 includes the subject matter of Example 13, wherein the O-CelIDTXDRX-Config IE includes an activationStatus information element (IE), the operations further including configuring the RAN based on the activationStatus IE to enable or disable activation of a DTX or DRX configuration for the cell.

Example 25 includes the subject matter of Example 13, wherein the O-CelIDTXDRX-Config IE includes an I1Activation information element (IE), the operations further including configuring the RAN based on the I1Activation IE to enable or disable Layer 1 (L1) signaling via Downlink Control Information (DCI) Format 2_9, to dynamically activate or dynamically deactivate a DTX or DRX configuration for the cell.

Example 26 includes a method to be performed at an apparatus to implement an E2 node in a radio-access network (RAN) of an Open Radio Access Network (O-RAN), causes the apparatus to perform operations including: determining a Near-Real-Time RAN-Intelligent-Controller (Near-RT RIC) communication from an E2 interface, the Near RT RIC communication including a cell-level energy-saving configuration information element (O-CellDTXDRX-Config IE); configuring a discontinuous transmission or reception (DTX/DRX) operation of the RAN in a cell of the RAN based on the O-CellDTXDRX-Config IE: and causing the RAN's DTX/DRX operation based on the O-CellDTXDRX-Config IE.

Example 27 includes the subject matter of Example 26, wherein the O-CelIDTXDRX-Config IE includes an onDurationTimer information element (IE), the method further including configuring the RAN based on the onDurationTimer IE to control a length of time that the cell remains in an active state during a DTX or DRX cycle.

Example 28 includes the subject matter of Example 27, wherein the OnDurationTimer IE is expressed in either submilliseconds or milliseconds, wherein a submillisecond field of the OnDuration Timer IE is to be represented as an integer ranging from 1 to 31, with values in multiples of 1/32 ms, and a millisecond field of the OnDuration Timer IE is to be represented as an enumerated value selected from a set of predefined durations in milliseconds.

Example 29 includes the subject matter of Example 26, wherein the O-CelIDTXDRX-Config IE includes a cycleStartOffset information element (IE), the method further including configuring the RAN based on the cycleStartOffset IE to control both a repetition interval and a starting point within an interval for a DTX or DRX cycle for the cell.

Example 30 includes the subject matter of Example 29, wherein the cycleStartOffset IE is based on: a periodicity based on predefined periodicities corresponding to cycle durations in milliseconds: and an integer offset value in milliseconds, to indicate a starting point of the DTX or DRX cycle within the periodicity.

Example 31 includes the subject matter of Example 29, wherein the cycleStartOffset IE includes: a periodicity field comprising an enumerated value indicating a duration of the DTX or DRX cycle: and an offset field comprising an integer value, in milliseconds, to define a timing offset for the starting point of the DTX or DRX cycle within a selected periodicity as indicated in the periodicity field, wherein the integer value of the offset field ranges from 0 ms up to 10232 ms.

Example 32 includes the subject matter of Example 31, wherein the enumerated value is one of 10 ms, 20 ms, 32 ms, 40 ms, 60 ms, 64 ms, 70 ms, 80 ms, 128 ms, 160 ms, 256 ms, 320 ms, 512 ms, 640 ms, 1024 ms, 1280 ms, 2048 ms, 2560 ms, 5120 ms, or 10240 ms and the integer value is based on the enumerated value.

Example 33 includes the subject matter of Example 32, wherein the integer value is based on the enumerated value.

Example 34 includes the subject matter of Example 26, wherein the O-CelIDTXDRX-Config IE includes a slotOffset information element (IE), the method further including configuring the RAN based on the slotOffset IE to align a start of active durations within a subframe in increments of 1/32 ms.

Example 35 includes the subject matter of Example 26, wherein the O-CelIDTXDRX-Config IE includes a configType information element (IE), the method further including configuring the RAN based on the configType IE to select whether the cell operates in DTX mode, DRX mode, or combined DTX and DRX mode.

Example 36 includes the subject matter of Example 26, wherein the O-CelIDTXDRX-Config IE includes an activationStatus information element (IE), the method further including configuring the RAN based on the activationStatus IE to enable or disable activation of a DTX or DRX configuration for the cell.

Example 37 includes the subject matter of Example 26, wherein the O-CelIDTXDRX-Config IE includes an I1Activation information element (IE), the method further including configuring the RAN based on the I1Activation IE to enable or disable Layer 1 (L1) signaling via Downlink Control Information (DCI) Format 2_9, to dynamically activate or dynamically deactivate a DTX or DRX configuration for the cell.

Example 38 includes an apparatus to implement an E2 node in a radio-access network (RAN) of an Open Radio Access Network (O-RAN), the apparatus including: means for determining a Near-Real-Time RAN-Intelligent-Controller (Near-RT RIC) communication from an E2 interface, the Near RT RIC communication including a cell-level energy-saving configuration information element (O-CellDTXDRX-Config IE); means for configuring a discontinuous transmission or reception (DTX/DRX) operation of the RAN in a cell of the RAN based on the O-CelIDTXDRX-Config IE: and means for causing the RAN's DTX/DRX operation based on the O-CelIDTXDRX-Config IE.

Example 39 includes the subject matter of Example 38, wherein the O-CelIDTXDRX-Config IE includes an onDurationTimer information element (IE), the apparatus further including means for configuring the RAN based on the onDurationTimer IE to control a length of time that the cell remains in an active state during a DTX or DRX cycle.

Example 40 includes the subject matter of Example 39, wherein the OnDurationTimer IE is expressed in either submilliseconds or milliseconds, wherein a submillisecond field of the OnDuration Timer IE is to be represented as an integer ranging from 1 to 31, with values in multiples of 1/32 ms, and a millisecond field of the OnDuration Timer IE is to be represented as an enumerated value selected from a set of predefined durations in milliseconds.

Example 41 includes the subject matter of Example 38, wherein the O-CelIDTXDRX-Config IE includes a cycleStartOffset information element (IE), the apparatus further including means for configuring the RAN based on the cycleStartOffset IE to control both a repetition interval and a starting point within an interval for a DTX or DRX cycle for the cell.

Example 42 includes the subject matter of Example 41, wherein the cycleStartOffset IE is based on: a periodicity based on predefined periodicities corresponding to cycle durations in milliseconds: and an integer offset value in milliseconds, to indicate a starting point of the DTX or DRX cycle within the periodicity.

Example 43 includes the subject matter of Example 41, wherein the cycleStartOffset IE includes: a periodicity field comprising an enumerated value indicating a duration of the DTX or DRX cycle: and an offset field comprising an integer value, in milliseconds, to define a timing offset for the starting point of the DTX or DRX cycle within a selected periodicity as indicated in the periodicity field, wherein the integer value of the offset field ranges from 0 ms up to 10232 ms.

Example 44 includes the subject matter of Example 43, wherein the enumerated value is one of 10 ms, 20 ms, 32 ms, 40 ms, 60 ms, 64 ms, 70 ms, 80 ms, 128 ms, 160 ms, 256 ms, 320 ms, 512 ms, 640 ms, 1024 ms, 1280 ms, 2048 ms, 2560 ms, 5120 ms, or 10240 ms and the integer value is based on the enumerated value.

Example 45 includes the subject matter of Example 44, wherein the integer value is based on the enumerated value.

Example 46 includes the subject matter of Example 38, wherein the O-CelIDTXDRX-Config IE includes a slotOffset information element (IE), the apparatus further including means for configuring the RAN based on the slotOffset IE to align a start of active durations within a subframe in increments of 1/32 ms.

Example 47 includes the subject matter of Example 38, wherein the O-CelIDTXDRX-Config IE includes a configType information element (IE), the apparatus further including means for configuring the RAN based on the configType IE to select whether the cell operates in DTX mode, DRX mode, or combined DTX and DRX mode.

Example 48 includes the subject matter of Example 38, wherein the O-CelIDTXDRX-Config IE includes an activationStatus information element (IE), the apparatus further including means for configuring the RAN based on the activationStatus IE to enable or disable activation of a DTX or DRX configuration for the cell.

Example 49 includes the subject matter of Example 38, wherein the O-CelIDTXDRX-Config IE includes an I1Activation information element (IE), the apparatus further including means for configuring the RAN based on the I1Activation IE to enable or disable Layer 1 (1) signaling via Downlink Control Information (DCI) Format 2_9, to dynamically activate or dynamically deactivate a DTX or DRX configuration for the cell.

Example 50 includes an apparatus to implement a Near-Real-Time RAN-Intelligent-Controller (Near-RT RIC) to communicate with an E2 node in a radio-access network (RAN) of an Open Radio Access Network (O-RAN), the apparatus comprising processing circuitry, and an E2 endpoint to couple to the processing circuitry to an E2 interface of the E2 node, the processing circuitry to: determine a Near-RT RIC communication to the E2 node, the Near RT RIC communication including a cell-level energy-saving configuration information element (O-CellDTXDRX-Config IE), the CellDTXDRX-Config IE to be used by the RAN to configure a discontinuous transmission or reception (DTX/DRX) operation of the RAN in a cell: and send for transmission the CellDTXDRX-Config IE to the E2 node by way of the E2 interface.

Example 51 includes the subject matter of Example 50, wherein the O-CelIDTXDRX-Config IE includes an onDurationTimer information element (IE), the OnDurationTimer IE to be used by the RAN to further configure the RAN to control a length of time that the cell remains in an active state during a DTX or DRX cycle.

Example 52 includes the subject matter of Example 51, wherein the OnDurationTimer IE is expressed in either submilliseconds or milliseconds, wherein a submillisecond field of the OnDuration Timer IE is to be represented as an integer ranging from 1 to 353, with values in multiples of 1/32 ms, and a millisecond field of the OnDuration Timer IE is to be represented as an enumerated value selected from a set of predefined durations in milliseconds.

Example 53 includes the subject matter of Example 51, wherein the O-CelIDTXDRX-Config IE includes a cycleStartOffset information element (IE), the cycleStartOffset IE to be used by the RAN to further configure the RAN to control both a repetition interval and a starting point within an interval for a DTX or DRX cycle for the cell.

Example 54 includes the subject matter of Example 53, wherein the cycleStartOffset IE is based on: a periodicity based on predefined periodicities corresponding to cycle durations in milliseconds: and an integer offset value in milliseconds, to indicate a starting point of the DTX or DRX cycle within the periodicity.

Example 55 includes the subject matter of Example 53, wherein the cycleStartOffset IE includes: a periodicity field comprising an enumerated value indicating a duration of the DTX or DRX cycle: and an offset field comprising an integer value, in milliseconds, to define a timing offset for the starting point of the DTX or DRX cycle within a selected periodicity as indicated in the periodicity field, wherein the integer value of the offset field ranges from 0 ms up to 10239 ms.

Example 56 includes the subject matter of Example 55, wherein the enumerated value is one of 10 ms, 20 ms, 32 ms, 40 ms, 60 ms, 64 ms, 70 ms, 80 ms, 128 ms, 160 ms, 256 ms, 320 ms, 512 ms, 640 ms, 1024 ms, 1280 ms, 2048 ms, 2560 ms, 5120 ms, or 10240 ms and the integer value is based on the enumerated value.

Example 57 includes the subject matter of Example 56, wherein the integer value is based on the enumerated value.

Example 58 includes the subject matter of Example 50, wherein the O-CelIDTXDRX-Config IE includes a slotOffset information element (IE), the slotOffset to be used by the RAN to further configure the RAN to align a start of active durations within a subframe in increments of 1/32 ms.

Example 59 includes the subject matter of Example 50, wherein the O-CelIDTXDRX-Config IE includes a configType information element (IE), the configType IE to be used by the RAN to further configure the RAN to select whether the cell operates in DTX mode, DRX mode, or combined DTX and DRX mode.

Example 60 includes the subject matter of Example 50, wherein the O-CelIDTXDRX-Config IE includes an activationStatus information element (IE), the activationStatus IE to be used by the RAN to further configure the RAN to enable or disable activation of a DTX or DRX configuration for the cell.

Example 61 includes the subject matter of Example 50, wherein the O-CelIDTXDRX-Config IE includes an I1Activation information element (IE), the I1Activation IE to be used by the RAN to further configure the RAN to enable or disable Layer 1 (L1) signaling via Downlink Control Information (DCI) Format 2_9, to dynamically activate or dynamically deactivate a DTX or DRX configuration for the cell.

Example 62 includes one or more tangible non-transitory machine readable storage media storing instructions that, when executed at an apparatus to implement a Near-Real-Time RAN-Intelligent-Controller (Near-RT RIC) to communicate with an E2 node in a radio-access network (RAN) of an Open Radio Access Network (O-RAN), causes the apparatus to perform operations including: determining a Near-RT RIC communication to the E2 node, the Near RT RIC communication including a cell-level energy-saving configuration information element (O-CellDTXDRX-Config IE), the CellDTXDRX-Config IE to be used by the RAN to configure a discontinuous transmission or reception (DTX/DRX) operation of the RAN in a cell; and sending for transmission the CellDTXDRX-Config IE to the E2 node by way of the E2 interface.

Example 63 includes the subject matter of Example 62, wherein the O-CelIDTXDRX-Config IE includes an onDurationTimer information element (IE), the OnDurationTimer IE to be used by the RAN to further configure the RAN to control a length of time that the cell remains in an active state during a DTX or DRX cycle.

Example 64 includes the subject matter of Example 63, wherein the OnDurationTimer IE is expressed in either submilliseconds or milliseconds, wherein a submillisecond field of the OnDuration Timer IE is to be represented as an integer ranging from 1 to 353, with values in multiples of 1/32 ms, and a millisecond field of the OnDuration Timer IE is to be represented as an enumerated value selected from a set of predefined durations in milliseconds.

Example 65 includes the subject matter of Example 63, wherein the O-CelIDTXDRX-Config IE includes a cycleStartOffset information element (IE), the cycleStartOffset IE to be used by the RAN to further configure the RAN to control both a repetition interval and a starting point within an interval for a DTX or DRX cycle for the cell.

Example 66 includes the subject matter of Example 65, wherein the cycleStartOffset IE is based on: a periodicity based on predefined periodicities corresponding to cycle durations in milliseconds: and an integer offset value in milliseconds, to indicate a starting point of the DTX or DRX cycle within the periodicity.

Example 67 includes the subject matter of Example 65, wherein the cycleStartOffset IE includes: a periodicity field comprising an enumerated value indicating a duration of the DTX or DRX cycle: and an offset field comprising an integer value, in milliseconds, to define a timing offset for the starting point of the DTX or DRX cycle within a selected periodicity as indicated in the periodicity field, wherein the integer value of the offset field ranges from 0 ms up to 10239 ms.

Example 68 includes the subject matter of Example 67, wherein the enumerated value is one of 10 ms, 20 ms, 32 ms, 40 ms, 60 ms, 64 ms, 70 ms, 80 ms, 128 ms, 160 ms, 256 ms, 320 ms, 512 ms, 640 ms, 1024 ms, 1280 ms, 2048 ms, 2560 ms, 5120 ms, or 10240 ms and the integer value is based on the enumerated value.

Example 69 includes the subject matter of Example 68, wherein the integer value is based on the enumerated value.

Example 70 includes the subject matter of Example 62, wherein the O-CelIDTXDRX-Config IE includes a slotOffset information element (IE), the slotOffset to be used by the RAN to further configure the RAN to align a start of active durations within a subframe in increments of 1/32 ms.

Example 71 includes the subject matter of Example 62, wherein the O-CelIDTXDRX-Config IE includes a configType information element (IE), the configType IE to be used by the RAN to further configure the RAN to select whether the cell operates in DTX mode, DRX mode, or combined DTX and DRX mode.

Example 72 includes the subject matter of Example 62, wherein the O-CelIDTXDRX-Config IE includes an activationStatus information element (IE), the activationStatus IE to be used by the RAN to further configure the RAN to enable or disable activation of a DTX or DRX configuration for the cell.

Example 73 includes the subject matter of Example 62, wherein the O-CelIDTXDRX-Config IE includes an I1Activation information element (IE), the I1Activation IE to be used by the RAN to further configure the RAN to enable or disable Layer 1 (L1) signaling via Downlink Control Information (DCI) Format 2_9, to dynamically activate or dynamically deactivate a DTX or DRX configuration for the cell.

Example 74 includes a method to be performed at an apparatus to implement a Near-Real-Time RAN-Intelligent-Controller (Near-RT RIC) to communicate with an E2 node in a radio-access network (RAN) of an Open Radio Access Network (O-RAN), the method including: determining a Near-RT RIC communication to the E2 node, the Near RT RIC communication including a cell-level energy-saving configuration information element (O-CellDTXDRX-Config IE), the CellDTXDRX-Config IE to be used by the RAN to configure a discontinuous transmission or reception (DTX/DRX) operation of the RAN in a cell; and sending for transmission the CellDTXDRX-Config IE to the E2 node by way of the E2 interface.

Example 75 includes the subject matter of Example 74, wherein the O-CelIDTXDRX-Config IE includes an onDurationTimer information element (IE), the OnDurationTimer IE to be used by the RAN to further configure the RAN to control a length of time that the cell remains in an active state during a DTX or DRX cycle.

Example 76 includes the subject matter of Example 75, wherein the OnDurationTimer IE is expressed in either submilliseconds or milliseconds, wherein a submillisecond field of the OnDuration Timer IE is to be represented as an integer ranging from 1 to 353, with values in multiples of 1/32 ms, and a millisecond field of the OnDuration Timer IE is to be represented as an enumerated value selected from a set of predefined durations in milliseconds.

Example 77 includes the subject matter of Example 75, wherein the O-CelIDTXDRX-Config IE includes a cycleStartOffset information element (IE), the cycleStartOffset IE to be used by the RAN to further configure the RAN to control both a repetition interval and a starting point within an interval for a DTX or DRX cycle for the cell.

Example 78 includes the subject matter of Example 77, wherein the cycleStartOffset IE is based on: a periodicity based on predefined periodicities corresponding to cycle durations in milliseconds: and an integer offset value in milliseconds, to indicate a starting point of the DTX or DRX cycle within the periodicity.

Example 79 includes the subject matter of Example 77, wherein the cycleStartOffset IE includes: a periodicity field comprising an enumerated value indicating a duration of the DTX or DRX cycle: and an offset field comprising an integer value, in milliseconds, to define a timing offset for the starting point of the DTX or DRX cycle within a selected periodicity as indicated in the periodicity field, wherein the integer value of the offset field ranges from 0 ms up to 10239 ms.

Example 80 includes the subject matter of Example 79, wherein the enumerated value is one of 10 ms, 20 ms, 32 ms, 40 ms, 60 ms, 64 ms, 70 ms, 80 ms, 128 ms, 160 ms, 256 ms, 320 ms, 512 ms, 640 ms, 1024 ms, 1280 ms, 2048 ms, 2560 ms, 5120 ms, or 10240 ms and the integer value is based on the enumerated value.

Example 81 includes the subject matter of Example 80, wherein the integer value is based on the enumerated value.

Example 82 includes the subject matter of Example 74, wherein the O-CelIDTXDRX-Config IE includes a slotOffset information element (IE), the slotOffset to be used by the RAN to further configure the RAN to align a start of active durations within a subframe in increments of 1/32 ms.

Example 83 includes the subject matter of Example 74, wherein the O-CelIDTXDRX-Config IE includes a configType information element (IE), the configType IE to be used by the RAN to further configure the RAN to select whether the cell operates in DTX mode, DRX mode, or combined DTX and DRX mode.

Example 84 includes the subject matter of Example 74, wherein the O-CelIDTXDRX-Config IE includes an activationStatus information element (IE), the activationStatus IE to be used by the RAN to further configure the RAN to enable or disable activation of a DTX or DRX configuration for the cell.

Example 85 includes the subject matter of Example 74, wherein the O-CelIDTXDRX-Config IE includes an I1Activation information element (IE), the I1Activation IE to be used by the RAN to further configure the RAN to enable or disable Layer 1 (L1) signaling via Downlink Control Information (DCI) Format 2_9, to dynamically activate or dynamically deactivate a DTX or DRX configuration for the cell.

Example 86 includes an apparatus to implement a Near-Real-Time RAN-Intelligent-Controller (Near-RT RIC) to communicate with an E2 node in a radio-access network (RAN) of an Open Radio Access Network (O-RAN), the apparatus including: means for determining a Near-RT RIC communication to the E2 node, the Near RT RIC communication including a cell-level energy-saving configuration information element (O-CellDTXDRX-Config IE), the CellDTXDRX-Config IE to be used by the RAN to configure a discontinuous transmission or reception (DTX/DRX) operation of the RAN in a cell: and means for sending for transmission the CellDTXDRX-Config IE to the E2 node by way of the E2 interface.

Example 87 includes the subject matter of Example 86, wherein the O-CelIDTXDRX-Config IE includes an onDurationTimer information element (IE), the OnDurationTimer IE to be used by the RAN to further configure the RAN to control a length of time that the cell remains in an active state during a DTX or DRX cycle.

Example 88 includes the subject matter of Example 87, wherein the OnDurationTimer IE is expressed in either submilliseconds or milliseconds, wherein a submillisecond field of the OnDuration Timer IE is to be represented as an integer ranging from 1 to 353, with values in multiples of 1/32 ms, and a millisecond field of the OnDuration Timer IE is to be represented as an enumerated value selected from a set of predefined durations in milliseconds.

Example 89 includes the subject matter of Example 87, wherein the O-CelIDTXDRX-Config IE includes a cycleStartOffset information element (IE), the cycleStartOffset IE to be used by the RAN to further configure the RAN to control both a repetition interval and a starting point within an interval for a DTX or DRX cycle for the cell.

Example 90 includes the subject matter of Example 89, wherein the cycleStartOffset IE is based on: a periodicity based on predefined periodicities corresponding to cycle durations in milliseconds: and an integer offset value in milliseconds, to indicate a starting point of the DTX or DRX cycle within the periodicity.

Example 91 includes the subject matter of Example 89, wherein the cycleStartOffset IE includes: a periodicity field comprising an enumerated value indicating a duration of the DTX or DRX cycle: and an offset field comprising an integer value, in milliseconds, to define a timing offset for the starting point of the DTX or DRX cycle within a selected periodicity as indicated in the periodicity field, wherein the integer value of the offset field ranges from 0 ms up to 10239 ms.

Example 92 includes the subject matter of Example 91, wherein the enumerated value is one of 10 ms, 20 ms, 32 ms, 40 ms, 60 ms, 64 ms, 70 ms, 80 ms, 128 ms, 160 ms, 256 ms, 320 ms, 512 ms, 640 ms, 1024 ms, 1280 ms, 2048 ms, 2560 ms, 5120 ms, or 10240 ms and the integer value is based on the enumerated value.

Example 93 includes the subject matter of Example 92, wherein the integer value is based on the enumerated value.

Example 94 includes the subject matter of Example 86, wherein the O-CelIDTXDRX-Config IE includes a slotOffset information element (IE), the slotOffset to be used by the RAN to further configure the RAN to align a start of active durations within a subframe in increments of 1/32 ms.

Example 95 includes the subject matter of Example 86, wherein the O-CelIDTXDRX-Config IE includes a configType information element (IE), the configType IE to be used by the RAN to further configure the RAN to select whether the cell operates in DTX mode, DRX mode, or combined DTX and DRX mode.

Example 96 includes the subject matter of Example 86, wherein the O-CelIDTXDRX-Config IE includes an activationStatus information element (IE), the activationStatus IE to be used by the RAN to further configure the RAN to enable or disable activation of a DTX or DRX configuration for the cell.

Example 97 includes the subject matter of Example 86, wherein the O-CelIDTXDRX-Config IE includes an I1Activation information element (IE), the I1Activation IE to be used by the RAN to further configure the RAN to enable or disable Layer 1 (L1) signaling via Downlink Control Information (DCI) Format 2_9, to dynamically activate or dynamically deactivate a DTX or DRX configuration for the cell.

Example A1 may include or relate to methods to support cell DTX/DRX support in E2SM-CCC.

Example A2 may include one embodiment of Example A1 and/or some other example herein, including a new RAN configuration structure, O-CellDTXDRX-Config. It may contains one or more of the following information elements (IEs):
onDurationTimer: duration of cell DTX/DRX in milli-second or multiples of 1/32 milli-second.
cycleStartOffset: periodicity and offset of cell DTX/DRX.
slotOffset: slot level offset.
configType: configuration for cell DTX only, cell DRX only, or joint cell DTX/DRX.
activationStatus: initial activation status of cell DTX/DRX.
I1Activation: indication of whether cell supports L1 signaling for dynamic activation/deactivation.

Example A3 may include one embodiment of Example A2 and/or some other example herein, wherein duration of cell DTX/DRX, onDurationTimer, is defined as the table in 9.3.y.

Example A4 may include one embodiment of Example A2 and/or some other example herein, periodicity and offset of cell DTX/DRX, cycleStartOffset, is defined as the table in 9.3.z1.

In another embodiment, it is defined as the table in 9.3.z2.

Example A5 may include one embodiment of Example A2 and/or some other example herein, wherein slot level offset of cell DTX/DRX, slotOffset, is defined as an INTEGER.

Example A6 may include one embodiment of Example A2 and/or some other example herein, wherein configType, is defined as an enumeration.

Example A7 may include one embodiment of Example A2 and/or some other example herein, wherein initial activation status of cell DTX/DRX, activationStatus, is defined as an enumeration.

Example A8 may include one embodiment of Example A2 and/or some other example herein, wherein indication of cell's enablement of L1 signalling for dynamic activation/deactivation of cell DTX/DRX, I1Activation, is defined as an enumeration.

Example Z01 may include an apparatus comprising means to perform one or more elements of a method described in or related to any of Examples 26-37 and 74-85, and/or any other method or process described herein.

Example Z02 may include one or more non-transitory computer-readable media comprising instructions to cause an electronic device, upon execution of the instructions by one or more processors of the electronic device, to perform one or more elements of a method described in or related to any of Examples 26-37 and 74-85, and/or any other method or process described herein.

Example Z03 may include an apparatus comprising logic, modules, or circuitry to perform one or more elements of a method described in or related to any of Examples 26-37 and 74-85, and/or any other method or process described herein.

Example Z04 may include a method, technique, or process as described in or related to any of Examples 26-37 and 74-85, and/or portions or parts thereof.

Example Z05 may include an apparatus comprising: one or more processors and one or more computer-readable media comprising instructions that, when executed by the one or more processors, cause the one or more processors to perform the method, techniques, or process as described in or related to any of Examples 26-37 and 74-85, and/or portions thereof.

Example Z06 may include a signal as described in or related to any of Examples 26-37 and 74-85, or portions or parts thereof.

Example Z07 may include a datagram, packet, frame, segment, protocol data unit (PDU), or message as described in or related to any of Examples 26-37 and 74-85, and/or portions or parts thereof, or otherwise described in the present disclosure.

Example Z08 may include a signal encoded with data as described in or related to any of Examples 26-37 and 74-85, and/or portions or parts thereof, or otherwise described in the present disclosure.

Example Z09 may include a signal encoded with a datagram, packet, frame, segment, protocol data unit (PDU), or message as described in or related to any of Examples 26-37 and 74-85, and/or portions or parts thereof, or otherwise described in the present disclosure.

Example Z10 may include an electromagnetic signal carrying computer-readable instructions, wherein execution of the computer-readable instructions by one or more processors is to cause the one or more processors to perform the method, techniques, or process as described in or related to any of Examples 26-37 and 74-85, and/or portions thereof.

Example Z11 may include a computer program comprising instructions, wherein execution of the program by a processing element is to cause the processing element to carry out the method, techniques, or process as described in or related to any of Examples 26-37 and 74-85, and/or portions thereof.

Example Z12 may include a signal in a wireless network as shown and described herein.

Example Z13 may include a method of communicating in a wireless network as shown and described herein.

Example Z14 may include a system for providing wireless communication as shown and described herein.

Example Z15 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

What is claimed is:

1. An apparatus to implement an E2 node in a radio-access network (RAN) of an Open Radio Access Network (O-RAN), the apparatus comprising processing circuitry, and a radio frequency (RF) interface to couple the processing circuitry to an RF circuitry, the processing circuitry to:
determine a Near-Real-Time RAN-Intelligent-Controller (Near-RT RIC) communication from an E2 interface, the Near RT RIC communication including a cell-level energy-saving configuration information element (O-CellDTXDRX-Config IE);
configure a discontinuous transmission or reception (DTX/DRX) operation of the RAN in a cell of the RAN based on the O-CellDTXDRX-Config IE; and
cause the RAN's DTX/DRX operation based on the O-CellDTXDRX-Config IE.

2. The apparatus of claim 1, wherein the O-CellDTXDRX-Config IE includes an onDurationTimer information element (IE), the processing circuitry to further configure the RAN based on the onDurationTimer IE to control a length of time that the cell remains in an active state during a DTX or DRX cycle.

3. The apparatus of claim 2, wherein the OnDurationTimer IE is expressed in either submilliseconds or milliseconds, wherein a submillisecond field of the OnDuration Timer IE is to be represented as an integer ranging from 1 to 31, with values in multiples of 1/32 ms, and a millisecond field of the OnDuration Timer IE is to be represented as an enumerated value selected from a set of predefined durations in milliseconds.

4. The apparatus of claim 1, wherein the O-CellDTXDRX-Config IE includes a cycleStartOffset information element (IE), the processing circuitry to further configure the RAN based on the cycleStartOffset IE to control both a repetition interval and a starting point within an interval for a DTX or DRX cycle for the cell.

5. The apparatus of claim 4, wherein the cycleStartOffset IE is based on:
a periodicity based on predefined periodicities corresponding to cycle durations in milliseconds; and
an integer offset value in milliseconds, to indicate a starting point of the DTX or DRX cycle within the periodicity.

6. The apparatus of claim 4, wherein the cycleStartOffset IE includes:
a periodicity field comprising an enumerated value indicating a duration of the DTX or DRX cycle; and
an offset field comprising an integer value, in milliseconds, to define a timing offset for the starting point of the DTX or DRX cycle within a selected periodicity as indicated in the periodicity field, wherein the integer value of the offset field ranges from 0 ms up to 10239 ms.

7. The apparatus of claim 6, wherein the enumerated value is one of 10 ms, 20 ms, 32 ms, 40 ms, 60 ms, 64 ms, 70 ms, 80 ms, 128 ms, 160 ms, 256 ms, 320 ms, 512 ms, 640 ms, 1024 ms, 1280 ms, 2048 ms, 2560 ms, 5120 ms, or 10240 ms and the integer value is based on the enumerated value.

8. The apparatus of claim 7, wherein the integer value is based on the enumerated value.

9. The apparatus of claim 1, wherein the O-CellDTXDRX-Config IE includes a slotOffset information element (IE), the processing circuitry to further configure the RAN based on the slotOffset IE to align a start of active durations within a subframe in increments of 1/32 ms.

10. The apparatus of claim 1, wherein the O-CellDTXDRX-Config IE includes a configType information element (IE), the processing circuitry to further configure the RAN based on the configType IE to select whether the cell operates in DTX mode, DRX mode, or combined DTX and DRX mode.

11. The apparatus of claim 1, wherein the O-CellDTXDRX-Config IE includes an activationStatus information element (IE), the processing circuitry to further configure the RAN based on the activationStatus IE to enable or disable activation of a DTX or DRX configuration for the cell.

12. The apparatus of claim 1, wherein the O-CellDTXDRX-Config IE includes an I1Activation information element (IE), the processing circuitry to further configure the RAN based on the I1Activation IE to enable or disable Layer 1 (L1) signaling via Downlink Control Information (DCI) Format 2_9, to dynamically activate or dynamically deactivate a DTX or DRX configuration for the cell.

13. One or more tangible non-transitory machine readable storage media storing instructions that, when executed at an apparatus to implement an E2 node in a radio-access network (RAN) of an Open Radio Access Network (O-RAN), causes the apparatus to perform operations including:
determining a Near-Real-Time RAN-Intelligent-Controller (Near-RT RIC) communication from an E2 interface, the Near RT RIC communication including a cell-level energy-saving configuration information element (O-CellDTXDRX-Config IE);
configuring a discontinuous transmission or reception (DTX/DRX) operation of the RAN in a cell of the RAN based on the O-CellDTXDRX-Config IE; and
causing the RAN's DTX/DRX operation based on the O-CellDTXDRX-Config IE.

14. The machine readable storage media of claim 13, wherein the O-CellDTXDRX-Config IE includes an onDurationTimer information element (IE), the operations further including configuring the RAN based on the onDurationTimer IE to control a length of time that the cell remains in an active state during a DTX or DRX cycle, wherein the OnDurationTimer IE is expressed in either submilliseconds or milliseconds, wherein a submillisecond field of the OnDuration Timer IE is to be represented as an integer ranging from 1 to 31, with values in multiples of 1/32 ms, and a millisecond field of the OnDuration Timer IE is to be represented as an enumerated value selected from a set of predefined durations in milliseconds.

15. The machine readable storage media of claim 13, wherein the O-CellDTXDRX-Config IE includes a cycleStartOffset information element (IE), the operations further including configuring the RAN based on the cycleStartOffset IE to control both a repetition interval and a starting point within an interval for a DTX or DRX cycle for the cell.

16. The machine readable storage media of claim 15, wherein the cycleStartOffset IE is based on:
a periodicity based on predefined periodicities corresponding to cycle durations in milliseconds; and
an integer offset value in milliseconds, to indicate a starting point of the DTX or DRX cycle within the periodicity.

17. The machine readable storage media of claim 15, wherein the cycleStartOffset IE includes:
a periodicity field comprising an enumerated value indicating a duration of the DTX or DRX cycle; and
an offset field comprising an integer value, in milliseconds, to define a timing offset for the starting point of the DTX or DRX cycle within a selected periodicity as indicated in the periodicity field, wherein the integer value of the offset field ranges from 0 ms up to 10239 ms.

18. An apparatus to implement a Near-Real-Time RAN-Intelligent-Controller (Near-RT RIC) to communicate with an E2 node in a radio-access network (RAN) of an Open Radio Access Network (O-RAN), the apparatus comprising processing circuitry, and an E2 endpoint to couple to the processing circuitry to an E2 interface of the E2 node, the processing circuitry to:
determine a Near-RT RIC communication to the E2 node, the Near RT RIC communication including a cell-level energy-saving configuration information element (O-CellDTXDRX-Config IE), the CellDTXDRX-Config IE to be used by the RAN to configure a discontinuous transmission or reception (DTX/DRX) operation of the RAN in a cell; and
send for transmission the CellDTXDRX-Config IE to the E2 node by way of the E2 interface.

19. The apparatus of claim 18, wherein the O-CellDTXDRX-Config IE includes a configType information element (IE), the configType IE to be used by the RAN to further configure the RAN to select whether the cell operates in DTX mode, DRX mode, or combined DTX and DRX mode.

20. The apparatus of claim 18, wherein the O-CellDTXDRX-Config IE includes an activationStatus information element (IE), the activationStatus IE to be used by the RAN to further configure the RAN to enable or disable activation of a DTX or DRX configuration for the cell.
